(19) United States
(12) Patent Application Publication
(10) Pub. No.: US 2006/0270802 A1
(43) Pub. Date: Nov. 30, 2006

(54) Optical functional film, composite film, and method for producing the same

(75) Inventors: Shintaro Washizu, Tokyo (JP); Hidekazu Yamazaki, Kanagawa (JP); Junichi Yamanouchi, Kanagawa (JP); Hideaki Naruse, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/441,123

(22) Filed: May 26, 2006

(30) Foreign Application Priority Data
May 27, 2005 (JP) 2005-156473

(51) Int. Cl. C08L 23/04; B29D 11/00

(52) U.S. Cl. 525/240; 264/1.6; 264/2.7; 264/1.34

(57) ABSTRACT

The object of the present invention is to provide an optical functional film containing a film having a structure of fine holes which contains ellipsoid or slit-like holes; and a composite film containing a film having a structure of fine ellipsoidal or slit-like holes and a metal layer on a surface of the film including inside portions of the holes; a method for producing an optical functional film which includes forming a film, and stretching the obtained film to form ellipsoidal or slit-like holes in the film, the forming the film comprises applying a coating solution containing an organic solvent and a high-polymer compound over a surface of a substrate, forming droplets in the obtained film, and vaporizing the organic solvent and the droplets to thereby produce a film having holes in the film; and a method for producing the composite film.

### BACKGROUND OF THE INVENTION

1. Field of the Invention

The present invention relates to an optical functional film and a composite film, each utilizing a honeycomb composite film which is produced by self-organization and relates to a method for producing the optical functional film, and a method for producing the composite film.

2. Description of the Related Art

For polarizing films, for example, there has been widely known a polarizing film which utilizes optical anisotropy and is obtained by stretching a high-polymer film (see Japanese Patent Application Laid-Open (JP-A) No. 2003-43257). Such a polarizing film made of a high-polymer film is mainly used for displaying purpose such as liquid crystal display panels. However, the polarizing film described in JP-A No. 2003-43257 is advantageous in low-cost performance and mass-productivity, because it is produced by using a high-polymer film. On the other hand, there are problems that the polarizing film is poor in heat resistance, humidity resistance, resistance to chemicals, and the like and has a low transmittance and a low extinction ratio from the viewpoint of optical properties.

For wire grid polarizers, there is known a polarizer which is formed such that a number of thin metallic wires are formed in parallel with each other on a transparent substrate (see Japanese Patent Application Laid Open (JP-A) No. 10-153706). The wire grid polarizer is produced by applying a resist over a surface of a transparent substrate, and patterning the resist by electron beam (EB) lithography or X-ray lithography such that the thin metallic wires are left on the transparent substrate using a lift-off method.

However, in the method for producing the wire grid polarizer described in JP-A No. 10-153706, an electron beam (EB) imaging device is used, and thus the area in which an image or images can be drawn at a time is small, takes a time for drawing an image, and is unsuitable for drawing images in a wide area. Further, X-ray lithography needs so much cost in terms of units and photo masks, and it is not a desirable method from the perspective of mass-productivity, and manufacture cost. In addition, in the method for producing a wire grid polarizer, a part of metallic fractions that have been lifted-off becomes residues to cause degradation of properties, and when an expensive noble metal is used, the most part of metallic portions to be lifted off is unnecessary material, and the method is disadvantageous in cost performance.

Recently, techniques of producing a film having an ordered structure utilizing self-organization phenomena are studied. For example, on pp. 327-329 and pp. 854-856 of “Thin Solid Films (1998)”, and on pp. 308-314 of “Chaos, 9-2 (1999), it is disclosed that droplets condensed from air, and polymer precipitated on the solvent interface self-accumulate in the three-phase boundary zone to thereby form a film having a honeycomb structure. Each of the methods described in these publications needs no complicated manufacturing apparatuses, because these methods utilize droplets condensed from the air, and polymer precipitated on the solvent interface.

However, these publications do not disclose nor suggest a specific use of the produced film and a specific method of controlling the conditions in accordance with the use. Accordingly, in order to put the film having a honeycomb structure in practical use as an optical functional film or a composite film, further studies and developments are necessary.

### SUMMARY OF THE INVENTION

It is therefore an object of the present invention to solve the conventional various problems and to achieve the following purposes. Specifically, the object of the present invention is to provide an optical functional film and a composite film that respectively have a high-polarization degree, allow easy increases in size to have a larger area, and excel in durability, as well as to provide a method for producing the optical functional film and a method for producing the composite film with efficiency at low-cost.

The means to solve the aforesaid problems are as follows.

<1> An optical functional film which contains a film having a structure of fine holes which contain ellipsoidal or slit-like holes.

<2> The optical functional film according to the item <1>, wherein the film having the structure of fine holes is a honeycomb-like porous film produced by self-organization.

<3> The optical functional film according to the item <1>, wherein the holes respectively open in an ellipsoid or a slit shape on a surface of the film and are arrayed linearly.

<4> The optical functional film according to the item <1>, wherein the film is subjected to a stretching treatment, and the stretching is any one selected from uniaxial stretching, sequential biaxial stretching, simultaneous biaxial stretching, and triaxial stretching.

<5> The optical functional film according to the item <1>, wherein the film has a metal layer on a surface thereof except for the hole portions.

<6> The optical functional film according to the item <5>, wherein the metal used for the metal layer is at least one selected from the group consisting of gold, silver, copper, aluminum, iron, nickel, titanium, tungsten, chrome, and alloys thereof.

<7> The optical functional film according to the item <1>, wherein the material of the film is at least one selected from the group consisting of hydrophobic polymers, and amphipathic compounds.

<8> The optical functional film according to the item <7>, wherein the amphipathic compounds are amphipathic polymers.

<9> The optical functional film according to the item <1>, further containing a substrate.

<10> The optical functional film according to the item <1>, the optical functional film is used as a polarizing film.

<11> A composite film which contains a film having a structure of fine holes which contain ellipsoidal or slit-like holes, and a metal layer, wherein the meal layer is formed on a surface of the film including inside portions of the holes.

<12> The composite film according to the item <11>, wherein the film is a honeycomb-like porous film produced by self-organization.

<13> The composite film according to the item <11>, wherein the film is subjected to a stretching treatment, and the stretching is any one selected from uniaxial stretching, sequential biaxial stretching, simultaneous biaxial stretching, and triaxial stretching.

<14> The composite film according to the item <11>, wherein the metal used for the metal layer is at least one selected from the group consisting of gold, silver, copper, aluminum, iron, nickel, titanium, tungsten, chrome, and alloys thereof.

<15> The composite film according to the item <11>, wherein the film having the structure of fine holes has a metal layer inside the holes and has a wire grid function.

<16> The composite film according to the item <11>, wherein the material of the film is at least one selected from the group consisting of hydrophobic polymers, and amphipathic compounds.

<17> The composite film according to the item <16>, wherein the amphipathic compounds are amphipathic polymers.

<18> The composite film according to the item <11>, further containing a substrate.

<19> The composite film according to the item <11>, wherein the optical functional film is used as a polarizing film.

<20> A method for producing an optical functional film including forming a film, and stretching the obtained film to form ellipsoidal or slit-like holes in the film, the forming the film includes applying a coating solution containing an organic solvent and a high-polymer compound over a surface of a substrate, forming droplets in the obtained film, and vaporizing the organic solvent and the droplets to thereby produce a film having holes in the film.

<21> The method for producing an optical functional film according to the item <20>, wherein the stretching is any one selected from uniaxial stretching, sequential biaxial stretching, simultaneous biaxial stretching, and triaxial stretching.

<22> The method for producing an optical functional film according to the item <20>, further containing forming a metal layer on a surface of the film except for the hole portions.

<23> The method for producing an optical functional film according to the item <22>, wherein the metal layer is formed by any one of methods selected from a vacuum evaporation method, a plating method, and an electrocasting method.

<24> A method for producing a composite film including forming a film, stretching the obtained film to form ellipsoidal or slit-like holes in the film, and forming a metal layer on a surface of the film including inside portions of the holes, the forming the film includes applying a coating solution containing an organic solvent and a high-polymer compound over a surface of a substrate, forming droplets in the obtained film, and vaporizing the organic solvent and the droplets to thereby produce a film having holes in the film.

<25> The method for producing a composite film according to the item <24>, wherein the stretching is any one selected from uniaxial stretching, sequential biaxial stretching, simultaneous biaxial stretching, and triaxial stretching.

<26> The method for producing a composite film according to the item <24>, wherein the metal layer is formed by any one of methods selected from a vacuum evaporation method, a plating method, and an electrocasting method.

### BRIEF DESCRIPTION OF THE DRAWINGS

FIG. 1 is a pattern diagram showing an example of the optical functional film of the present invention.

FIG. 2 is a process chart explaining one example of the method for producing an optical functional film or a composite film of the present invention.

FIG. 3 is a schematic diagram of a film production unit used as one example of the method for producing an optical functional film or a composite film of the present invention.

FIG. 4A is a schematic diagram showing one example of the method for producing an optical functional film or a composite film of the present invention and illustrating a state where a high-polymer film is formed on a flow casting belt.

FIG. 4B is a schematic diagram showing one example of the method for producing an optical functional film or a composite film of the present invention and illustrating a state where droplets are condensed to grow up.

FIG. 4C is a schematic diagram showing one example of the method for producing an optical functional film or a composite film of the present invention and illustrating a state where the organic solvent is volatilized from the high-polymer film by dry air.

FIG. 4D is a schematic diagram showing one example of the method for producing an optical functional film or a composite film of the present invention and illustrating a state where the moisture content is volatilized from the droplets of the high-polymer film by dry air.

FIG. 5A is a top view showing one example of a honeycomb composite film of the present invention.

FIG. 5B is a cross-sectional diagram as viewed from the line b-b of the honeycomb composite film shown in FIG. 5A.

FIG. 5C is a cross-sectional diagram as viewed from the line c-c of the honeycomb composite film shown in FIG. 5A.

FIG. 6 is a schematic diagram showing another example of a film production unit used for the method for producing an optical functional film or a composite film of the present invention.

FIG. 7 is a schematic diagram showing yet another example of a film production unit used for the method for producing an optical functional film or a composite film of the present invention.

FIG. 8 is a schematic diagram showing still yet another example of a film production unit used for the method for producing an optical functional film or a composite film of the present invention.

FIG. 9 is a schematic diagram showing still yet another example of a film production unit used for the method for producing an optical functional film or a composite film of the present invention.

FIG. 10 is a schematic diagram showing still yet another example of a film production unit used for the method for producing an optical functional film or a composite film of the present invention.

### DESCRIPTION OF THE PREFERRED EMBODIMENTS

(Optical Functional Film and Composite Film)

The optical functional film of the present invention has a film having a structure of fine holes which contain ellipsoidal or slit-like holes, a metal layer, and a substrate, and further has other structures in accordance with the necessity.

The optical functional film preferably has a metal layer on a surface thereof except for the hole portions.

The composite film of the present invention has a film having a structure of fine holes which contain ellipsoidal or slit-like holes, a metal layer formed on a surface of the film including inside portions of the holes, and a substrate, and further has other structures in accordance with the necessity.

It is preferable that the film having a structure of fine holes in the optical functional film and the composite film be a honeycomb-like porous film produced by self-organization and be subjected to a stretching treatment.

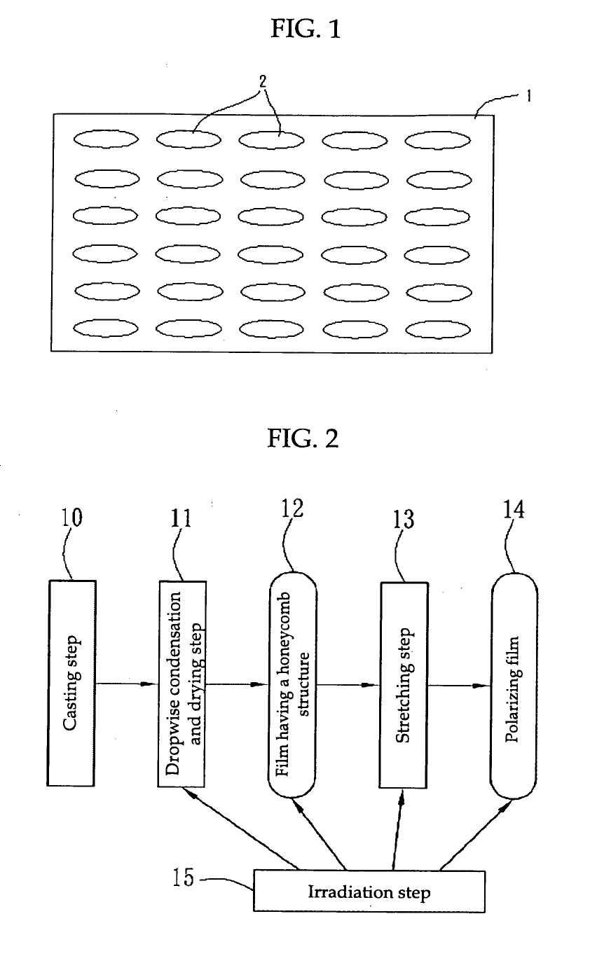

Here, the ellipsoidal or slit-like holes, as shown in FIG. 1, open in an ellipsoid or a slit shape and are arrayed linearly, and each of the holes is surrounded by a wall surface.

-Film Having a Structure of Fine Holes-

The material of the film having a structure of fine holes is not particularly limited and may be suitably selected in accordance with the intended use. For example, it is preferable to use at least one selected from hydrophobic polymers and amphipathic compounds.

The hydrophobic polymers are not particularly limited, may be suitably selected from among hydrophobic polymers known in the art, and examples thereof include vinyl polymers such as polyethylene, polypropylene, polystyrene, polyacrylate, polymethacrylate, polyacrylamide, polymethacrylamide, polyvinyl chloride, polyvinylidene chloride, polyvinylidene fluoride, polyhexafluoropropene, polyvinyl ether, polyvinyl carbazole, polyvinyl acetate, and polytetrafluoroethylene; polyesters such as polyethylene terephthalate, polyethylene naphthalate, polyethylene succinate, polybutylene succinate, and polylactate; polylactones such as polycaprolacton; polyamides or polyimides such as nylon and polyamide acid; polyurethanes, polyureas, polycarbonates, polyaromatics, polysulfones, polyether sulfones, and polysiloxane derivatives. These hydrophobic polymers may be in the form of a homopolymer, a copolymer, or a polymer blend from the perspective of solubility, optical properties, electrical physical properties, film strength and elastic property. Each of these polymers may be used alone or in combination with two or more.

The amphipathic compounds are not particularly limited and may be suitably selected in accordance with the intended use, and examples thereof include amphipathic polymers.

The amphipathic polymers are not particularly limited, may be suitably selected in accordance with the intended use, and examples thereof include amphipathic polymers having polyacrylamide as the main skeleton, a dodecyl group as hydrophobic side chains, and a carboxyl group as hydrophilic side chains; polyethyleneglycol/polypropyleneglycol-blocked copolymers.

It is preferable that the hydrophobic side chains be nonpolar straight chain groups such as methylene groups, and phenylene groups and have a structure which does not branch hydrophilic groups such as polar groups and ionic dissociation groups to the terminals, except for linked-groups such as ester groups and amide groups. The hydrophobic side chains preferably contain 5 or more methylene units when a methylene group is used.

It is preferable that the hydrophilic side chains have a structure having hydrophilic sites such as polar groups, ionic dissociation groups or oxyethylene groups at the terminals thereof through linked portions such as methylene groups.

The ratio of the hydrophobic side chains to the hydrophilic side chains differs depending on the size, the strength of nonpolarity or polarity of the hydrophobic side chains and the hydrophilic side chains, and the strength of hydrophobicity of the hydrophobic organic solvent, and cannot be uniformly defined. However, the unit ratio (hydrophobic side chains/hydrophilic side chains) is preferably 9.9/0.1 to 5.5/4.5. In the case of a copolymer, the copolymer is preferably a block copolymer in which a block is formed with hydrophobic side chains and hydrophilic side chains within the range where it does not affect the solubility to the hydrophobic solvent, rather than an alternating polymer of hydrophobic side chains and hydrophilic side chains.

The number average molecular mass (Mn) of the hydrophobic polymer and the amphipathic compound is preferably 10,000 to 10,000,000, and more preferably 50,000 to 1,000,000.

Examples of the amphipathic compound include amphipathic compounds other than the amphipathic polymers. The amphipathic compounds other than the amphipathic polymers are not particularly limited, may be suitably selected in accordance with the intended use, and preferred examples thereof include surfactants.

The surfactants are not particularly limited, and examples thereof include compounds represented by the following General Formula (I).

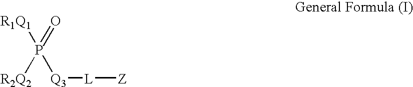

In the General Formula (I), R₁ represents any one of an aliphatic group, an alicyclic compound group, an aromatic group, and a heterocycle; R₂ represents any one of an aliphatic group, an alicyclic compound group, an aromatic group, a heterocycle, and -L-Z; Q₁, Q₂, and Q₃ respectively represent any one of a single bond, an oxygen atom, a sulfur atom, and —N(R₃)—; R₃ represents any one of hydrogen atom and R₂; L represents a divalent-bonded group; and Z represents an ionic group. It should be noted that “single bond” means that there is no element.

In the General Formula (I), preferred examples of the aliphatic group represented by R₁ include straight chain or branched nonsubstituted alkyl groups having 1 to 40 carbon atoms, straight chain or branched substituted alkyl groups having 1 to 40 carbon atoms, straight chain or branched nonsubstituted alkenyl groups having 2 to 40 carbon atoms, straight chain or branched substituted alkenyl groups having 2 to 40 carbon atoms, straight chain or branched nonsubstituted alkynyl groups having 2 to 40 carbon atoms, and straight chain or branched substituted alkynyl groups having 2 to 40 carbon atoms.

Examples of the straight chain or branched nonsubstituted alkyl groups having 1 to 40 carbon atoms include methyl groups, ethyl groups, n-propyl groups, iso-propyl groups, n-butyl groups, sec-butyl groups, tert-butyl groups, n-amyl groups, tert-amyl groups, n-hexyl groups, n-heptyl groups, n-octyl groups, tert-octyl groups, 2-ethylhexyl groups, n-nonyl groups, 1,1,3-trimethylhexyl groups, n-decyl groups, n-dodecyl groups, cetyl groups, hexadecyl groups, 2-hexyldecyl groups, octadecyl groups, icosyl groups, 2-octyldodecyl groups, docosyl groups, tetracosyl groups, 2-decyltetradecyl groups, and tricosyl groups.

Examples of the straight chain or branched substituted alkyl groups having 1 to 40 carbon atoms include alkoxyl groups, ary groups, halogen atoms, carbon ester groups, carbon amide groups, carbamoyl groups, oxycarbonyl groups, and phosphoester groups. Specific examples thereof include benzyl groups, β-phenethyl groups, 2-methoxyethyl groups, 4-phenylbutyl groups, 4-acetoxyethyl groups, 6-phenoxyhexyl groups, 12-phenyldodecyl groups, 18-phenyloctadecyl groups, heptadecyl fluorooctyl groups, 12-(p-chlorophenyl) dodecyl groups, and 2-(diphenyl phosphate)ethyl groups.

Examples of the straight chain or branched nonsubstituted alkenyl groups having 2 to 40 carbon atoms include vinyl groups, allyl groups, 3-butenyl groups, 2-methyl-2-butenyl groups, 4-pentenyl groups, 3-pentenyl groups, 3-methyl-3-pentenyl groups, 5-hexenyl groups, 4-hexenyl groups, 3-hexenyl groups, 2-hexenyl groups, 7-octenyl groups, 9-decenyl groups, oleyl groups, linoleyl groups, and linolenyl groups.

Examples of the straight chain or branched substituted alkenyl groups having 2 to 40 carbon atoms include 2-phenylvinyl groups, 4-acetyl-2-butecyl groups, 13-methoxy-9-octadecenyl groups, and 9,10-dibromo-12-octadecenyl groups.

Examples of the straight chain or branched nonsubstituted alkynyl groups having 2 to 40 carbon atoms include acetylene groups, propargyl groups, 3-butynyl groups, 4-pentynyl groups, 5-hexynyl groups, 4-hexynyl groups, 3-hexynyl groups, and 2-hexynyl groups.

Examples of the straight chain or branched substituted alkynyl groups having 2 to 40 carbon atoms include alkoxyl groups, and aryl groups. Specific examples thereof include 2-phenyl acetylene group, and 3-phenyl propargyl group.

In the General Formula (I), preferred examples of the alicyclic compound group represented by R₁ include substituted or nonsubstituted cycloalkyl groups having 3 to 40 carbon atoms, and substituted or nonsubstituted cycloalkenyl groups having 4 to 40 carbon atoms.

Preferred examples of the aromatic group include substituted or nonsubstituted aryl groups having 6 to 50 carbon atoms.

Examples of the substituted or nonsubstituted cycloalkyl groups having 3 to 40 carbon atoms in the alicyclic compound group include cyclo propyl groups, cyclohexyl groups, 2,6-dimethylcyclohexyl group, 4-tert-butylcyclohexyl group, 4-phenylcyclohexyl group, 3-methoxycyclohexyl group, and cycloheptyl groups.

Examples of the substituted or nonsubstituted cycloalkenyl groups having 4 to 40 carbon atoms include 1-cyclohexenyl group, 2-cyclohexenyl group, 3-cyclohexenyl group, 2,6-dimethyl-3-cyclohexenyl group, 4-tert-butyl-2-cyclohexenyl group, 2-cycloheptenyl group, and 3-methyl-3-cycloheptenyl group.

Examples of substituted groups of aryl groups having 6 to 50 carbon atoms in the aromatic groups include alkyl groups, alkoxyl groups, aryl groups, and halogen atoms. Specific examples thereof include phenyl groups, 1-naphthyl groups, 2-naphthyl groups, anthranil groups, o-cresyl groups, m-cresyl groups, p-cresyl groups, p-ethylphenyl groups, p-tert-butylphenyl group, 3,5-di-tert-butylphenyl group, p-n-amylphenyl group, p-tert-amylphenyl group, 2,6-dimethyl-4-tert-butylphenyl group, p-cyclohexyl phenyl groups, octylphenyl groups, p-tert-octylphenyl group, nonylphenyl groups, p-n-dodecylphenyl group, m-methoxyphenyl groups, p-butoxyphenyl groups, m-octyloxyphenyl groups, biphenyl groups, m-chlorophenyl groups, pentachlorophenyl groups, and 2-(5-methylnaphtyl groups).

In the General Formula (I), preferred examples of the heterocycle include substituted or nonsubstituted cyclic ethers having 4 to 40 carbon atoms, and substituted or nonsubstituted nitrogenous rings having 4 to 40 carbon atoms.

Examples of the substituted or nonsubstituted cyclic ethers having 4 to 40 carbon atoms include furyl groups, 4-butyl-3-furyl group, pyranyl groups, 5-octyl-2H-pyran-3-yl group, isobenzofuranyl groups, and chromenyl groups.

Examples of the substituted or nonsubstituted nitrogenous rings having 4 to 40 carbon atoms include 2H-pyrrolyl group, imidazolyl group, pyrazolyl group, indolidinyl group, and morphoryl group.

Of these, straight chain, cyclic, or branched nonsubstituted alkyl groups having 1 to 24 carbon atoms; straight, cyclic, or branched substituted alkyl groups having 1 to 24 carbon atoms excluding the carbon atoms of the substituted groups therein; straight chain, cyclic, or branched substituted alkyl groups having 1 to 24 carbon atoms; straight chain, cyclic, or branched nonsubstituted alkenyl groups having 2 to 24 carbon atoms; straight chain, cyclic, or branched substituted alkenyl groups having 2 to 24 carbon atoms; and substituted or nonsubstituted aryl groups having 6 to 30 carbon atoms are particularly preferable.

Examples of the straight chain, cyclic, or branched nonsubstituted alkyl group having 1 to 24 carbon atoms include methyl groups, ethyl groups, n-propyl groups, n-butyl groups, n-amyl groups, n-hexyl groups, cyclohexyl groups, n-heptyl groups, n-octyl groups, 2-ethylhexyl group, n-nonyl groups, 1,1,3-trimethylhexyl group, n-decyl groups, n-dodecyl groups, cetyl groups, hexadecyl groups, 2-hexyldecyl group, octadecyl groups, icosyl groups, 2-octyldodecyl group, docosyl groups, tetracodyl group, and 2-decyltetradecyl group.

Examples of the straight chain, cyclic, or branched substituted alkyl groups having 1 to 24 carbon atoms excluding the carbon atoms of the substituted groups therein include 6-phenoxyhexyl group, 12-phenyldodecyl group, 18-phenyloctadecyl group, heptadecyl fluorooctyl group, 12-(p-chlorophenyl) dodecyl group, and 4-tert-butylcyclohexyl group.

Examples of the straight chain, cyclic, or branched nonsubstituted alkenyl group having 2 to 24 carbon atoms include vinyl groups, allyl groups, 2-methyl-2-butenyl group, 4-pentenyl group, 5-hexenyl group, 3-hexenyl group, 3-cyclohexenyl group, 7-octenyl group, 9-decenyl group, oleyl groups, linoleyl groups, and linolenyl groups.

Examples of the straight chain, cyclic, or branched substituted alkenyl groups having 2 to 24 carbon atoms include 2-phenylvinyl group, and 9,10-dibromo-12-octadecenyl group.

Examples of the substituted or nonsubstituted aryl groups having 6 to 30 carbon atoms include phenyl group, 1-naphthyl group, 2-naphthyl group, p-cresyl group, p-ethylphenyl group, p-tert-butylphenyl group, p-tert-amylphenyl group, octylphenyl group, p-tert-octylphenyl group, nonylphenyl group, p-n-dodecylphenyl group, m-octyloxyphenyl group, and biphenyl group.

In the General Formula (I), as for Q₁, Q₂, and Q₃, a single bond, an oxygen atom, or —N(R₃)— is preferable, and it is particularly preferable that at least two or more of the Q₁, Q₂, and Q₃ be individually an oxygen atom.

In the General Formula (I), L is preferably a group represented by the following General Formula (II).

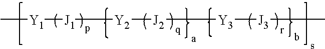

In the General Formula (II), Y₁, Y₂, and Y₃ respectively represent any one of a substituted and nonsubstituted alkylene group having 1 to 40 carbon atoms, and a substituted or nonsubstituted arylene group having 6 to 40 carbon atoms which may be the same to each other or may be different to each other; J₁, J₂, and J₃ respectively represent a divalent bonded unit which may be the same to each other or may be different to each other; p, q, and r individually represent an integer of 0 to 5; “s” represents an integer of 1 to 10; and a and b individually represent an integer of 0 to 50.

Examples of the substituted groups in Y₁, Y₂, and Y₃ include groups exemplarily shown in R₁ in the General Formula (I). Specific preferred examples of the alkylene group include methylene groups, ethylene groups, propylene groups, trimethylene groups, tetramethylene groups, pentamethylene groups, hexamethylene groups, 1,4-cyclohexylene group, octamethylene groups, decamethylene groups, and 2-methoxy-1,3-propylene groups. Specific preferred examples of the arylene group include o-phenylene groups, m-phenylene groups, p-phenylene groups, 3-chloro-1,4-phenylene group, 1,4-naphthylene group, and 1,5-naphthylene group. Of these, ethylene groups, propylene groups, trimethylene groups, tetramethylene groups, pentamethylene groups, hexamethylene groups, 1,4-cyclohexylene group, octamethylene groups, decamethylene groups, m-phenyl groups, and p-phenylene groups are particularly preferable.

Preferred examples of the divalent bonded unit in J₁, J₂, and J₃ include single bonds, —O—, —S—, —CO—, —COO—, —OCO—, —CON(R₄)—, —N(R₄)CO—, —CON(R₄)CO—, —N(R₄)CON(R₅)—, —OCON(R₄)—, —N(R₄)COO—, —SO₂—, SO₂N(R₄)—, —N(R₄)SO₂—, —N(COR₄)—, and —OP(═O)(OR₁)O—. In the examples of the divalent bonded unit, R₁ represents the same as R₁ in the General Formula (I); R₄ represents any one of hydrogen atom, a nonsubstituted alkyl group having 1 to 6 carbon atoms, and a substituted alkyl group having 1 to 6 carbon atoms excluding the carbon atoms of the substituted groups therein; and R₅ represents the same as R₄, however, they may be the same to each other or may be different to each other. Examples of the substituted groups in R₄ and R₅ include aryl groups, alkoxyl groups, and halogen atom.

Of these, —O—, —S—, —CO—, —COO—, —OCO—, —CON(R₃)— (R₃ represents hydrogen atom, a methyl group, an ethyl group, or a propyl group), —N(R₄)CO—, SO₂N(R₄)—, and —N(R₄)SO₂— are particularly preferable.

As for the p, q, and r, an integer of 0 to 3 is preferable, individually, and an integer of 0 or 1 is particularly preferable.

As for the s, an integer of 1 to 5 is preferable, and an integer of 1 to 3 is particularly preferable. As for the a and b, an integer of 0 to 20 is preferable, and an integer of 0 to 10 is particularly preferable.

As for Z in the General Formula (I), a hydrophilic anionic or cationic ion group is preferable, and a hydrophilic anionic ion group is particularly preferable.

As for the anionic group, —COOM, —SO₃M, —OSO₃M, —PO(OM)₂—PO (OM)₂ are particularly preferable. The M represents a pair of cations, and particularly preferable examples are any one selected from alkali metal ions such as lithium ion, sodium ion, and potassium ion; alkali earth metal ions such as magnesium ion, and calcium ion); and ammonium ions. Of these, sodium ion, and potassium ion are particularly preferable.

Examples of the cationic group include —NH₃⁺.X⁻, —NH₂(R₆)⁺.⁻, —NH(R₆)₂⁺.X⁻, and —N(R₆)₃⁺.X⁻.

The R₆ represents an alkyl group having 1 to 3 carbon atoms such as methyl group, ethyl group, 2-hydroxyethyl group, n-propyl group, and iso-propyl group. Of these, methyl group and 2-hydroxyethyl group are preferable.

The X represents a pair of anions; and preferred examples are halogen ion such as fluorine ion, chloride ion, and bromine ion; complex inorganic anion such as hydroxide ion, sulfate ion, nitrate ion, and phosphate ion; and organic compound anion such as oxalate ion, formate ion, acetate ion, propionate ion, methansulfonate ion, and p-toluenesulfonate ion. Of these, chloride ion, sulfate ion, nitrate ion, and acetate ion are particularly preferable.

In the General Formula (I), examples of the R₂ include monovalent groups selected from the groups exemplarily shown in R₁, and the groups exemplarily shown in the -L-Z. When R₂ is selected from the groups exemplarily shown in R₁, R₂ may take the same structure as that of R₁ which exists in the same molecule or may take a different structure from that of R₁ which exists in the same molecule. Of these, a group selected from the groups exemplarily shown in R₁ is particularly preferable. More preferably, the total number of carbon atoms of R₁ and R₂ is 6 to 80, and particularly preferably, the total number is 8 to 50.

Hereinafter, specific examples of the surfactant will be exemplarily described, however, the surfactant used in the present invention is not limited to the disclosed examples.

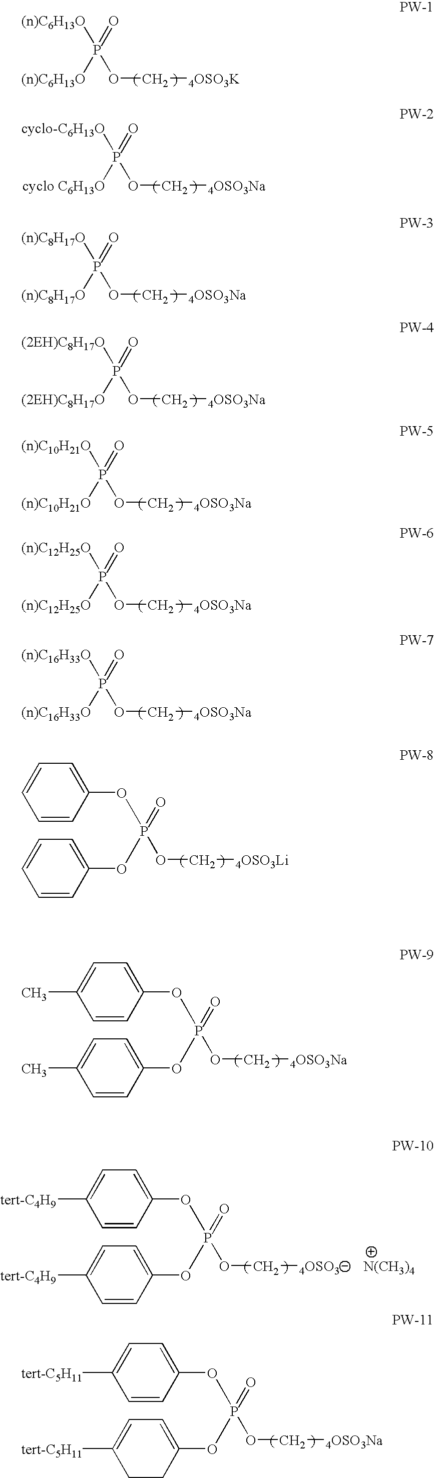

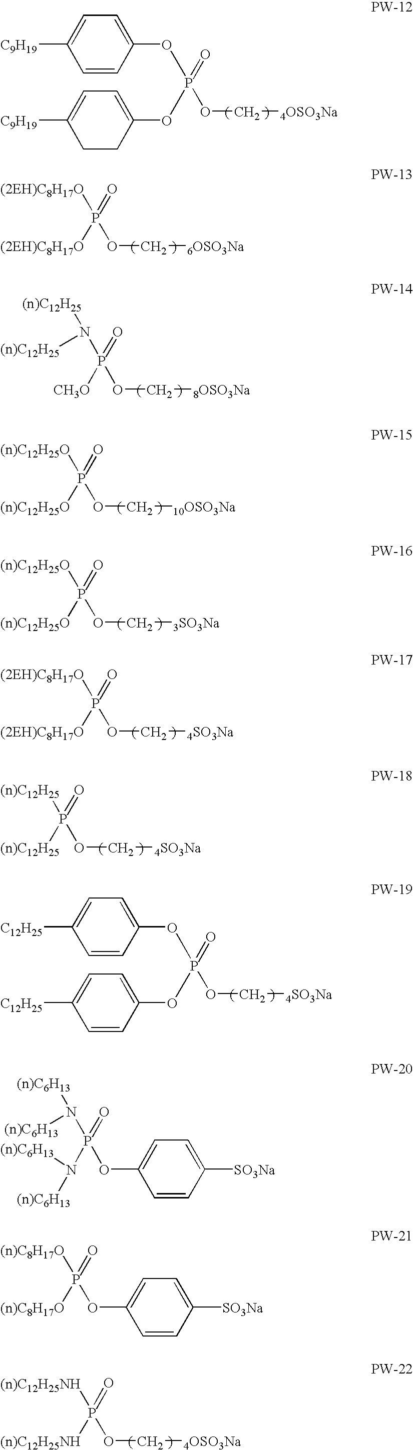

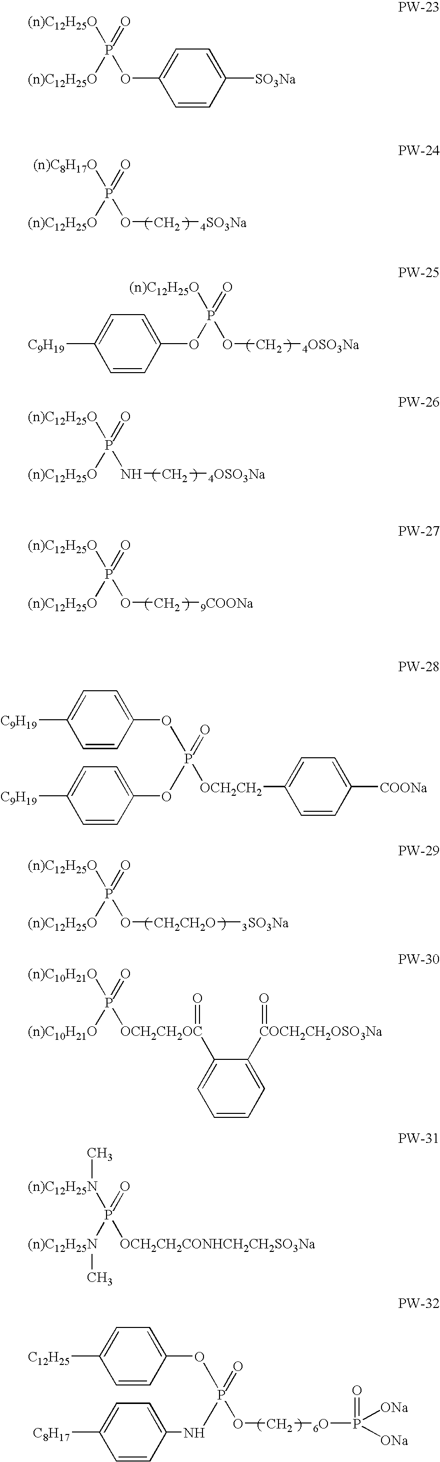

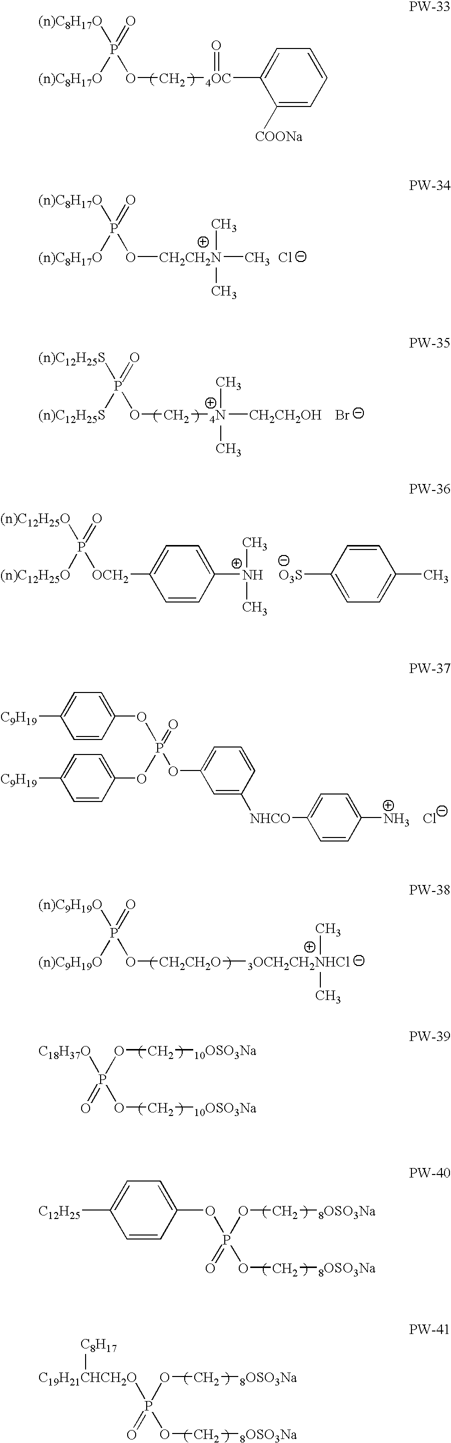

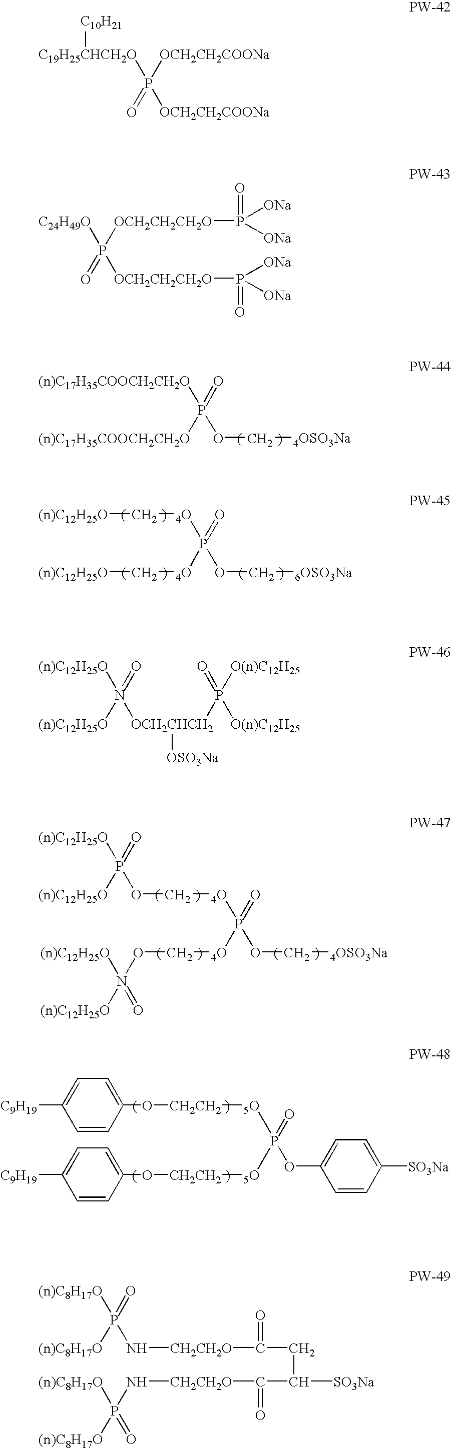

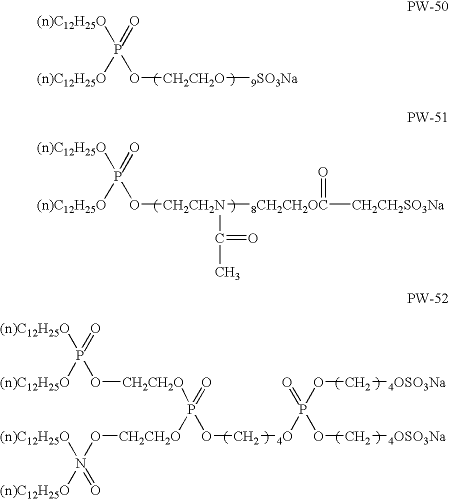

It is possible to form a film having a honeycomb structure using the hydrophobic polymer alone, however, it is preferable to use the hydrophobic polymer along with an amphipathic compound.

The composition ratio (mass ratio) of the hydrophobic polymer to the amphipathic compound is preferably 99:1 to 50:50, and more preferably 95:5 to 75:25. When the composition ratio of the amphipathic compound is less than 1% by mass, a uniformly formed film having a honeycomb structure may not be obtained. In contrast, when the composition ratio of the amphipathic compound is more than 50% by mass, the stability of the film, in particular, sufficient dynamic stability may not be obtained.

When the amphipathic compound is not an amphipathic polymer, the composition ratio (mass ratio) of the hydrophobic polymer to the amphipathic compound is preferably 99.9:0.1 to 80:20. When the composition ratio of the amphipathic compound is less than 0.1% by mass, a uniformly formed film having a honeycomb structure may not be obtained. In contrast, when the composition ratio of the amphipathic compound is more than 20% by mass, it may negatively affect the film strength because the amphipathic compound has a low molecular weight.

It is also preferable that the hydrophobic polymer and the amphipathic polymer be polymerization (cross-linking) polymers having a polymerization group in the molecules. In addition, it is also preferable that a polyfunctional polymerization polymer be compounded along with the hydrophobic polymer and/or the amphipathic polymer to form a honeycomb-like film by use of the compound and then be subjected to a curing treatment by one of the methods known in the art such as a heat curing method, a ultraviolet curing method, and an electron radiation curing method.

For the polyfunctional monomer to be used in combination with the hydrophobic polymer and/or the amphipathic polymer, it is preferable to use polyfunctional (meth)acrylates from the perspective of reactivity. It is possible to use polyfunctional (meth)acrylates such as dipentaerithritol pentaacrylate, dipentaerithritol hexaacrylate, hexaacrylates of dipentaerithritol caprolacton adducts or modified products thereof, epoxyacrylate oligomers, polyester acrylate oligomers, urethane acrylate oligomers, N-vinyl-2-pyrolidone, tripropylene glycol diacrylate, polyethylene glycol diacrylate, trimethylol propane triacrylate, pentaerythritol triacrylate, pentaerythritol tetraacrylate, or modified products thereof. Each of these polyfunctional monomers may be used alone or in combination of two or more depending on the balance between abrasion resistance and flexibility.

When the hydrophobic polymer and the amphipathic polymer are respectively a polymerization (cross-linking) polymer having a polymerization group in the molecules, it is also preferable that a polyfunctional polymerization monomer capable of reacting with polymerization groups of the hydrophobic polymer and the amphipathic polymer be used along with the hydrophobic polymer and the amphipathic polymer.

A monomer having ethylene-unsaturated groups is polymerizable by applying ionization radiation to the monomer or by heating the monomer in the presence of a photo-radical initiator or a thermal-radical initiator.

Specifically, a coating solution containing a monomer having an ethylene-unsaturated group, a photo-radical initiator or a thermal-radical initiator, mat particles, and an inorganic filler, is prepared; the coating solution is applied over a surface of a transparent substrate; and then the substrate surface is cured by means of a polymerization reaction by applying ionization radiation or heating to thereby form an antireflection film.

Examples of the photo-radical polymerization initiator include acetophenones, benzoins, benzophenones, phosphine oxides, ketals, anthraquinones, thioxanthones, azo compounds, peroxides, 2,3-alkyl dione compounds, disulfide compounds, fluoro amine compounds, and aromatic sulfoniums.

Examples of the acetophenones include 2,2-ethoxy acetophenone, p-methyl acetophenone, 1-hydroxydimethyl phenyl ketone, 1-hydroxy cyclohexyl phenyl ketone, 2-methyl-4-methylthio-2-morphorino propiophenone, and 2-benzil-2-dimethylamino-1-(4-morphorinophenyl)-butanone.

Examples of the benzoins include benzoin-benzene sulfonate esters, benzoin-toluene sulfonate esters, benzoin methyl ethers, benzoin ethyl ethers, and benzoin isopropyl ethers.

Examples of the benzophenones include benzophenones, 2,4-chlorobenzophenone, 4,4-dichlorobenzophenone, and p-chlorobenzophenone.

Examples of the phosphine oxides include 2,4,6-trimethyl benzoyl diphenyl phosphine oxide.

With respect to the photo-radical polymerization initiator, various examples are described in the “The Latest UV Curing Technology” (on page 159, issued by Kazuhiro Takausu, TECHNICAL INFORMATION INSTITUTE CO., LTD. in 1991).

Preferred examples of commercially available photofragmentation type photo-radical polymerization initiators include Irgacure (651, 184, and 907) or the like manufactured by Chiba Specialty Chemicals K.K.

The photo-polymerization initiator is preferably used within the range of 0.1 parts by mass to 15 parts by mass, and more preferably used within the range of 1 part by mass to 10 parts by mass relative to 100 parts by mass of the polyfunctional monomer.

In addition to the photo-polymerization initiator, a photosensitizer may be used. Specific examples of the photosensitizer include n-butylamines, trimethyl amines, tri-n-butyl phosphine, Michler's ketone, and thioxanthones.

As for the thermal-radical initiator, it is possible to use, for example, organic peroxides, inorganic peroxides, organic azo compounds, and organic diazo compounds.

Specific examples of the organic peroxides include benzoyl peroxides, halogen benzoyl peroxides, lauroyl peroxides, acetyl peroxides, dibutyl peroxides, cumene hydroperoxides, and butyl-hydroperoxides. Examples of the inorganic peroxides include hydrogen peroxides, ammonium persulfates, and potassium persulfates. Examples of the azo compounds include 2,2′-azobis (isobutylonitrile), 2,2′-azobis(propionitrile), and 1,1′-azobis(cyclohexane carbonitrile). Examples of the diazo compound include diazoaminobenzene, and p-nitrobenzene diazonium.

The honeycomb structure in the honeycomb-like porous film produced by self-organization means a structure in which holes formed in a given shape and in a given size are continuously arrayed with regularity. This regular array is allowed two-dimensionally when the honeycomb-like porous film is a single layer, and it is allowed to have regularity three-dimensionally when the honeycomb-like porous film is a multilayer. Two-dimensionally, the regularity takes a structure in which one hole is arranged so as to be surrounded by a plurality of holes, for example, 6 holes. Three-dimensionally, the regularity takes a structure like a face-centered cube of a crystalline structure or a hexagonal crystal and often takes a closest packed structure, however, the honeycomb-like porous film may show regularities other than the regularities depending on the production conditions.

When the film having a honeycomb structure is produced, it is essential to form microscopic water droplet particles on a polymer solution, and thus, the solvent to be used is preferably water-insoluble. Examples of the water-insoluble solvent include halogen-based organic solvents such as chloroform, and methylene chloride; aromatic hydrocarbons such as benzene, toluene, and xylene; esters such as ethyl acetate, and butyl acetate; water-insoluble ketones such as methylisobutyl ketone; ethers such as diethyl ether; and carbon disulfide. Each of these water-insoluble solvents may be used alone or used as a mixture solvent in a combination with two or more.

The combined polymer concentration of the hydrophobic polymer and the amphipathic polymer to be dissolved in the water-insoluble solvent is preferably 0.02% by mass to 20% by mass, and more preferably 0.05% by mass to 10% by mass. When the polymer concentration is less than 0.02% by mass, the dynamic strength of a film to be obtained may be insufficient, and there may be troubles that the size of microporous holes and the array become irregular. When the combined polymer concentration is more than 20% by mass, it may be difficult to obtain a satisfactory film having a honeycomb structure.

The pore diameter of holes of the film having a structure of fine holes is preferably 50.0 μm or less, and more preferably 100 nm to 2,000 nm. When the pore diameter of the holes is greater than 50.0 μm, the film strength may be degraded, resulting in a tear of the film with ease in the course of stretching.

Here, in order to make the pore diameter of the film having a structure of fine holes smaller, accelerating the drying in a speedy way is effective. For example, it is effective to use a low-boiling point solvent as the solvent for use, to increase the temperature of the substrate, to increase the developing rate of a developing solution to reduce the thickness of the developing solution at the early stage, and the like.

The thickness of the film having a structure of fine holes is preferably 0.1 μm to 1.0 mm. By increasing the polymer concentration to be developed, a relatively thick layer having no holes can be formed on the substrate surface side. In this case, it is preferable that the thickness of the relatively thick layer having no holes on the substrate surface side be 500 μm or less.

-Stretching-

It is preferable that the optical functional film of the present invention be obtained by stretching the film.

The stretching is preferably any one of stretching methods selected from uniaxial stretching, sequential biaxial stretching, simultaneous biaxial stretching, and triaxial stretching.

The stretching is not particularly limited and can be carried out by using various stretching machines. For example, it is possible to preferably utilize longitudinal uniaxial stretching machines which stretch a material in a direction of mechanical flow, and tentering stretching machines which stretch a material in a direction perpendicular to the mechanical flow direction.

The stretching magnification ratio is not particularly limited and may be suitably selected in accordance with the intended use. For example, when the film having a structure of fine holes is stretched in one direction, the stretching magnification ratio is preferably 1.05 times to 12 times, and more preferably 1.2 times to 10 times. In the case of biaxial stretching, the stretching magnification ratio is preferably 1.2 times to 60 times, and more preferably 1.5 times to 50 times, in dimensional magnification.

The stretching enables forming ellipsoidal or slit-like holes, particularly, enables forming holes each having an ellipsoidal or a slit-shaped opening on the surface of the film.

In this case, it is preferable, as shown in FIG. 1, that the holes 2 respectively open in an ellipsoid or a slit shape on the surface of the honeycomb-like porous film 1 and be arrayed linearly from the perspective that a wire grid function can be exerted. The wire grid function will be hereinafter described.

-Metal Layer-

A metal layer is to be formed on the surface of the film having holes which respectively open in an ellipsoid or a slit shape.

When a composite film is formed, a metal layer is formed on a surface of the film including inside portions of the holes.

When an optical functional film is formed, it is preferable that a metal layer be formed on a surface of the film except for the hole portions.

The metal used for the metal layer is preferably at least one selected from the group consisting of gold, silver, copper, aluminum, iron, nickel, titanium, tungsten, chrome, and alloys thereof.

The method for forming the metal layer is not particularly limited and may be suitably selected in accordance with the intended use, and examples of the method include plating methods, printing methods, sputtering methods, CVD methods, vacuum evaporation methods, and electrocasting methods. Of these methods, vacuum evaporation methods, plating methods, and electrocasting methods are particularly preferable.

The thickness of the metal layer is not particularly limited and may be suitably selected in accordance with the intended use, for example, when the composite film has a structure in which only a metal layer is formed on the film surface, the thickness is preferably 50 nm to 1,000 nm.

When the composite film is formed, the film preferably has a metal layer in the holes of the film surface and has a wire grid function. Specifically, by making the film have a structure such that ellipsoidal or slit-like holes are arrayed linearly on the film surface, and the film has a metal layer in the holes, it is possible to form a structure closely resembling a structure in which a number of metal wires are arrayed so as to be parallel each other at regular intervals.

Examples of a method for forming a metal layer in the holes on the film surface include a method of which a film layer is formed on a surface of the film, and then the metal layer portions other than the holes are removed by etching.

-Substrate-

The optical functional film of the present invention preferably has a substrate. The material used for the substrate is not particularly limited and may be suitably selected in accordance with the intended use, provided that the material is transparent and has a certain degree of strength. Examples of the material used for the substrate include inorganic materials such as glass, metals, and silicon wafers; polyesters such as polyethylene terephthalate, and polyethylene phthalate; polyolefins such as polyethylene, and polypropylene; organic materials which excel in organic solvent resistance such as polyamides, polyethers, polystyrenes, polyester amides, polycarbonates, polyphenylene sulfides, polyether esters, polyvinyl chlorides, polyacrylic acid esters, polymethacrylic acid esters, polyether ketones, and polyethylene fluorides; liquids such as water, liquid paraffins, and fluid polyethers.

The thickness of the substrate is not particularly limited and may be suitably selected in accordance with the intended use, provided that the substrate has a thickness within the range typically employed, however, it is preferably 0.005 mm to 4.0 mm.

-Usage-

The optical functional film and the composite film of the present invention can be preferably used as, for example, polarizing films, and electromagnetic stickers, because they respectively have a high-polarization degree, can be easily made to have a large area, and excel in durability. Particularly, the optical functional film and the composite film can be preferably used as polarizing films.

(Method for Producing Optical Functional Film and Composite Film)

The method for producing an optical functional film of the present invention includes a film formation step, a stretching step, and may include a metal layer formation step, and further includes other steps in accordance with the necessity.

The method for producing a composite film of the present invention includes a film formation step, a stretching step, a metal layer formation step, and further includes other steps in accordance with the necessity.

-Formation of Film-

The film formation step is a step in which a solution containing an organic solvent and a high-polymer compound is cast on a substrate to form a film, droplets are formed in the film, and the organic solvent and the droplets are vaporized to thereby prepare a film having holes in the film.

The casting method is not particularly limited and may be suitably selected in accordance with the intended use. Examples of the method include slide methods, extrusion methods, bar methods, and gravure methods.

As the environmental conditions under which the film is formed, the relative humidity is preferably within the range of 50% to 95%. When the relative humidity is less than 50%, the water condensation may be insufficient on the surface of the solvent, and when the relative humidity is more than 95%, it is difficult to control the environmental conditions, which may hardly keep a uniform film.

As the environmental conditions under which the film is formed, besides relative humidity, it is preferable that steady wind of a constant airflow volume be applied to the substrate surface with the solution applied thereon. The air blasting speed relative to the film is preferably 0.05 m/s to 20 m/s. When the air blasting speed is slower than 0.05 m/s, it may be difficult to control the environmental conditions. When the air blasting speed is faster than 20 m/s, it may cause distortion of the surface of the solvent, and a uniform film may not be obtained.

For the direction in which the steady wind is applied to the substrate surface, the film can be produced by applying steady wind in any one of the directions from 0° C. to 90° C. with respect to the substrate surface, however, in order to increase the uniformity of the film having a honeycomb structure, the direction is preferably 0° C. to 60° C. with respect to the substrate surface.

As a humidity and airflow-volume controlled gas to be delivered when the film is formed, for example, it is possible to use inactive gas such as nitrogen gas, and argon gas, besides air, however, it is preferable that the gas be preliminarily subjected to a dust-removal treatment, for example, by passing the gas through a filter. Since dust in the atmosphere become condensation nucleus to affect formation of films, it is preferable to set a dust-removal unit in manufacturing sites, too.

It is preferable that the environment in which the film is formed be strictly controlled, for example, by using a commercially available generator of constant dew point temperature and humidity. It is preferred that the airflow volume be controlled at a constant level using an air blower or the like, and a closed room be used to prevent influence from outside air. In addition, preferably, gas-inlet and exit paths and film-forming environments are set in the room such that the gas is substituted into a streamlined flow. Further, to control the quality of film-formation, it is preferred to monitor the state of film-formation by using instruments for measuring temperature, humidity, airflow volume, and the like. To highly precisely control the pore diameter and the film thickness, it is necessary to strictly control these parameters, in particular, parameters of humidity and airflow volume.

-Stretching-

The stretching step is a step in which the film having a honeycomb structure is stretched, and ellipsoidal or slit-like holes are formed in the film having a honeycomb structure.

The stretching is preferably any one of stretching methods selected from uniaxial stretching, sequential biaxial stretching, simultaneous biaxial stretching, and triaxial stretching.

The stretching may be carried out in any one of directions of a longitudinal direction and a lateral direction. When the stretching is carried out in a longitudinal direction, the stretching can be achieved by making the delivery speed of airflow at the exit side faster than the delivery speed of airflow at the inlet side, using one or more pairs of nip rolls. In contrast, when the stretching is carried out in a lateral direction, the stretching can be achieved by a method of which both ends of the film are held with a chuck, and the film is stretched in the width direction (tenter stretching). Each of these methods may be used alone or in combination with two or more for stretching.

-Formation of Metal Layer-

The metal layer forming step is a step in which a metal layer is formed on a surface of the film.

In the case of the composite film, a metal layer is to be formed on a surface of the film including inside portions of the holes.

In the case of the optical functional film, it is preferable that a metal layer be formed on the film surface except for the hole portions.

Examples of the method of forming the metal layer include plating method, printing methods, sputtering methods, CVD methods, vacuum evaporation methods, and electrocasting methods. Of these methods, vacuum evaporation methods, and electrocasting methods are particularly preferable.

The electrocasting means manufacturing or replication of metal products by electroplating.

Here, FIG. 2 shows a process chart explaining one example of the method for producing a film of the present invention. A high-polymer solution is cast on a surface of a substrate, and a film (hereinafter, it may be referred to as “high-polymer film”) is formed by a casting step. Thereafter, water is made to condense itself to be contained as droplets in the high-polymer film, by a dropwise condensation and drying step 11. The dropwise condensation and drying step 11 will be described below in detail. The solvent of the high-polymer solution and droplets are vaporized to thereby obtain a film having a honeycomb structure 12. The film having a honeycomb structure 12 is stretched by a stretching step 13 to thereby obtain an optical functional film 14. An irradiation step 15 may be carried out during the time when the optical functional film 14 is obtained from the high-polymer film. In this case, ultraviolet rays and electron beam can be used as irradiation light. Further, it is needed to carry out formation of a metal layer by which a metal layer is formed on the film surface, although the step is omitted in the figure.

As a material of the film having a honeycomb structure 12, a high-polymer compound which can be dissolved in the aforesaid water-insoluble solvent (hereinafter, it may be referred to as “lipophilic high-polymer compound”) is preferably used.

The film having a honeycomb structure 12 can be formed using the lipophilic high-polymer compound alone, however, it is preferable to add an amphipathic material thereto. For the amphipathic material, it can be suitably selected from among the aforesaid materials for use.

As the solvent used for preparing a high-polymer solution in which each of the high-polymer compounds is dissolved, it can be suitably selected from among the aforesaid solvent materials for use.

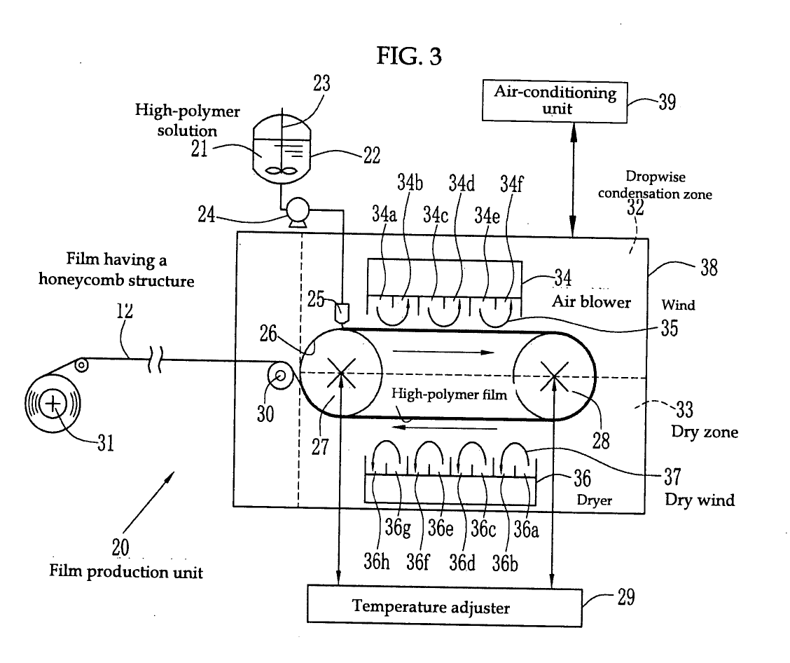

FIG. 3 is a schematic diagram showing one example of a film production unit 20 used for producing a film 12 of the present invention. The high-polymer solution 21 is poured in a tank 22. The tank 22 is equipped with a stirring blade 23, and the high-polymer solution 21 is uniformly mixed by rotation of the stirring blade 23. The high-polymer solution 21 is delivered to a casting die 25 by action of a pump 24. The casting die 25 is mounted above a flow casting belt 26 which is spanned over rotation rollers 27 and 28. A driving unit (not shown) drives the rotation rollers 27 and 28 to rotate to thereby make the flow casting belt 26 driven to rotate in an endless manner. A temperature adjuster 29 is mounted at the rotation roller 27 and 28. By adjusting the temperature of the rotation rollers 27 and 28, the temperature of the flow casting belt 26 can be controlled. The film production unit 20 is also provided with a film-exfoliation roller 30 which supports a high-polymer film 40 when a high-polymer film 40 on the flow casting belt 26 is stripped, and a rewinder 31 which rewinds the high-polymer film 40 as a film.

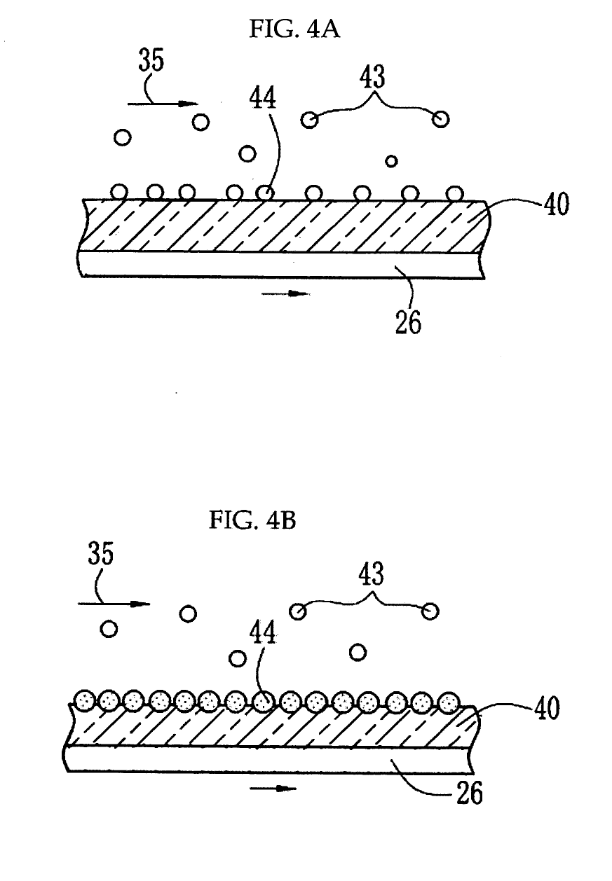

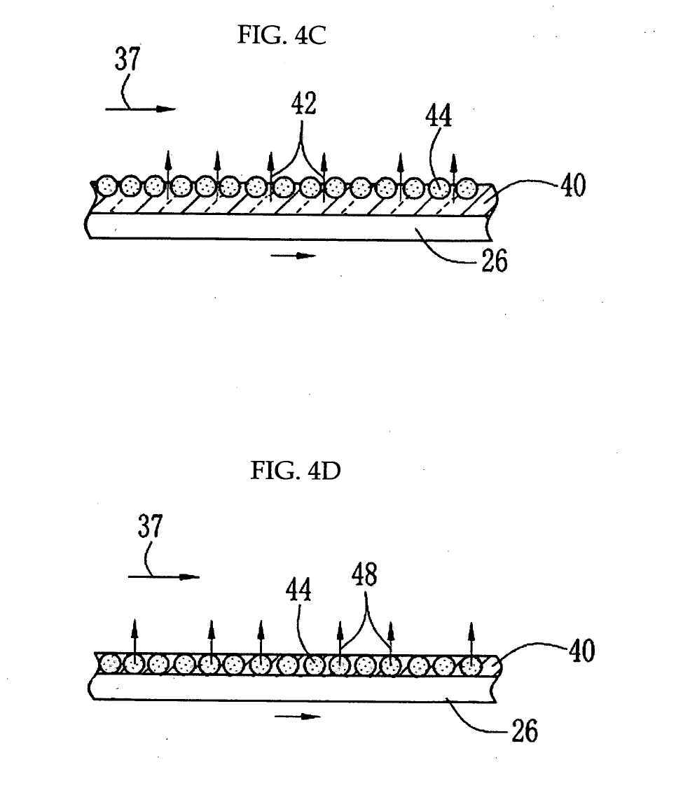

In the casting step 10, the high-polymer solution 21 is cast on the flow casting belt 26 from the casting die 25, and subsequently the dropwise condensation and drying step 11 is carried out. The dropwise condensation and drying step 11 will be described with reference to FIGS. 4A to 4D. As shown in FIG. 4A, the high-polymer film 40 is formed on the flow casting belt 26. The surface temperature (hereinafter, it may be referred to as “film surface temperature”) of the high-polymer film 40 is represented by TL (° C.). In the present invention, the film surface temperature TL is preferably 0° C. or more. When the film surface temperature TL is lower than 0° C., droplets in the high-polymer film 40 may coagulate only to prevent forming desired holes.

The casting chamber in which the high-polymer solution 21 is cast on the flow casting belt 26 is partitioned into a dropwise condensation zone 32 and a drying zone 33. An air blower 34 is provided in the dropwise condensation zone 32. Wind 35 adjusted by the air blower 34 for dropwise condensation is sent to the high-polymer film 40 on the flow casting belt 26. The air blower 34 is preferably composed of a plurality of blast units, as shown in FIG. 3, blast vents 34a, 34c, and 34e, and vacuum vents 34b, 34d, and 34f. This layout makes it easy to control conditions of dropwise condensation. In FIG. 3, an embodiment of an air blower which is composed of 3 units is illustrated, however, the present invention is not limited to the illustrated embodiment.

A dryer 36 is provided in the drying zone 33. Dry air 37 is sent from the dryer 36 to the high-polymer film 40. It is preferable that the dryer 36 be also composed of a plurality of blast units, as shown in FIG. 3, blast vents 36a, 36c, 36e and 36g, and vacuum vents 36b, 36d, 36f, and 36h. This layout makes it easy to control conditions of dying the high-polymer film 40. In FIG. 3, an embodiment of an air dryer which is composed of 4 units, is illustrated, however, the present invention is not limited to the illustrated embodiment.

It is more preferable to adjust the temperature of the flow casting belt 26 through rotation rollers 27 and 28 using the temperature adjuster 29. Examples of the method for adjusting the temperature include a method of which a liquid flow channel is provided inside of the rotation rollers 27 and 28, and a heating medium is sent to the liquid flow channel to thereby adjust the temperature of the flow casting belt 26. For adjusting the temperature, the lower limit temperature of the flow casting belt 26 is preferably 0° C. or more. The upper limit temperature of the flow casting belt 26 is preferably set to the solvent boiling point of the high-polymer solution 21 or less, and more preferably set to 3° C. lower than the solvent boiling point. With this configuration, condensed dropwise moisture does not coagulate, and it prevents the solvent of the high-polymer solution 21 from rapidly evaporating, and thus a film having a honeycomb structure 12 excelling in shape can be obtained. Further, for the temperature adjustment, by setting the temperature distribution of the high-polymer film 40 in the width direction within ±3° C. of the solvent boiling point, the film surface temperature distribution can also be set within ±3° C. of the solvent boiling point. By reducing the temperature distribution of the high-polymer film 40 in the width direction, it prevents occurrence of anisotropy in formation of holes of the film having a honeycomb structure 12. Thus, the commodity value is improved.

Further, the transportation direction of the flow casting belt 26 is preferably set at an angle within ±10° to the horizontal direction. By controlling the transportation direction, the shape of droplets 44 can be controlled. By controlling the shape of the droplets 44, the shape of the holes can be controlled.

The dryer 34 is sending wind 35. The dew point TD1 (° C.) of wind 35 is preferably 0° C.≦(TD1−TL) 0° C., more preferably 0° C.<(TD1−TL)° C.≦80° C., still more preferably 5° C. to 60° C., and particularly preferably 10° C. to 40° C. relative to the surface temperature TL (° C.) of the high-polymer film 40 which is passing through the dropwise condensation zone 32. When the temperature (TD1−TL) ° C. is lower than 0° C., dropwise condensation may hardly occur, and when the temperature (TD1−TL) ° C. is higher than 80° C., dropwise condensation and drying are precipitously induced, and control of the size of the holes and formation of the holes may be difficult with uniformity. The temperature of wind 35 is not particularly limited, may be suitably selected in accordance with the intended use, however, the temperature is preferably 5° C. to 100° C. When the temperature of wind 35 is lower than 5° C., the liquid, in particular, water is hardly vaporized, and a film having a honeycomb structure 12 which is excellent in shape may not be obtained. When the temperature of wind 35 is higher than 100° C., water possibly vaporizes as water vapor before the droplets 44 are generated within the high-polymer film 40.

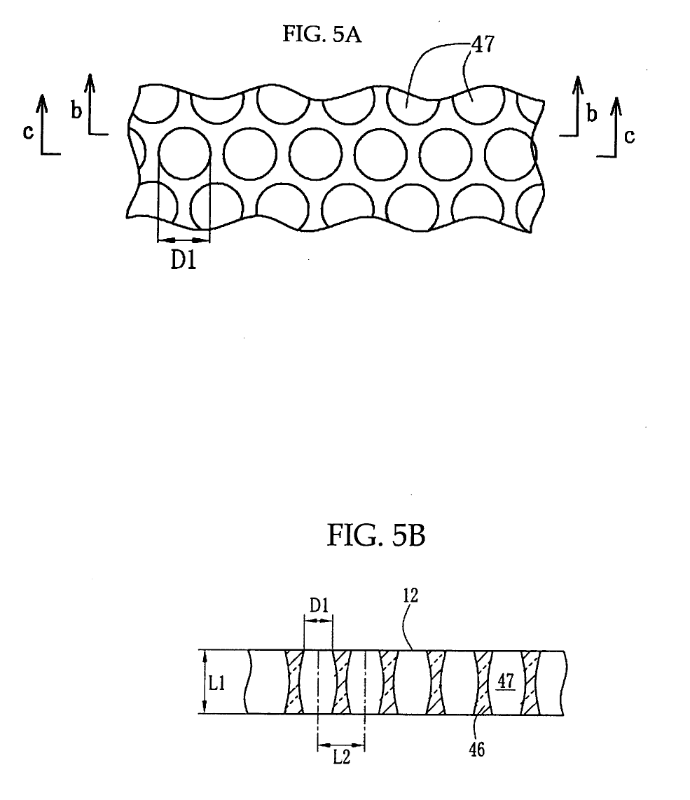

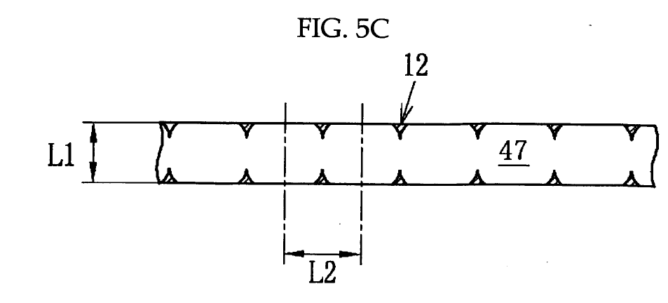

As shown in FIG. 4A, moisture 43 (illustrated visually) in wind 35 is condensed on the high-polymer film 40 to become droplets 44, in the dropwise condensation zone 32. Then, as shown in FIG. 4B, the moisture 43 is condensed to grow the droplets 44 as nuclear. With reference to FIG. 4C, when dry air 37 is sent to the high-polymer film 40 in the dry zone 33, an organic solvent 42 vaporizes from the high-polymer film 40. Here, moisture also vaporizes from the droplets 44, however, the vaporization rate of the organic solvent 42 is faster than that of the droplets 44. For the reason, the droplets 44 are substantially uniformly formed by surface tension, along with the vaporization of the organic solvent 42. Further, with advancing drying of the high-polymer film 40, as shown in FIG. 4D, moisture from the droplets 44 of the high-polymer film 40 vaporizes as water vapor 48. When the droplets 44 vaporize from the high-polymer film 40, the portions at which the droplets 44 are formed become holes 47, and a film having a honeycomb structure 12 as shown in FIGS. 5A, 5B, and 5C can be obtained. In the present invention, the form of the film having a honeycomb structure 12 is not particularly limited, however, specifically, the distance L2 between two adjacent holes 47, when measured as center-to-center spacing, can be controlled within the range of 0.05 μm to 100 μm.

The direction to which the wind 35 is sent is the parallel current flow along the moving direction of the high-polymer film 40. When the wind 35 is sent as the counter current flow, the film surface of the high-polymer film 40 may be distorted, and the growth of the droplets 44 may be inhibited. As for the air blasting speed of wind 35, the relative speed to the moving speed of the high-polymer film 40 is preferably 0.05 m/s to 20 m/s, more preferably 0.1 m/s to 15 m/s, and still more preferably 2 m/s to 10 m/s. When the air blasting speed is slower than 0.05 m/s, the high-polymer film 40 is possibly sent to the dry zone 33 in a state where the droplets 44 are not sufficiently grown up in the high-polymer film 40. When the air blasting speed is faster than 20 m/s, the film surface of the high-polymer film 40 may be distorted, and dropwise condensation may not adequately make progress.

The time during the high-polymer film 40 is passing through the dropwise condensation zone 32 is preferably 0.1 seconds to 6,000 seconds. When the transit time is less than 0.1 seconds, it may be difficult to form desired holes, because the droplets are formed in a state where the droplets 44 are not sufficiently grown up in the high-polymer film 40. When the transit time is more than 6,000 seconds, the size of the droplets 44 is excessively large, and a film having a honeycomb structure may not be obtained.

The air blasting speed of the dry air 37 which dries the high-polymer film 40 at the dry zone 33 is preferably 0.05 m/s to 20 m/s, more preferably 0.1 m/s to 15 m/s, and still more preferably 0.5 m/s to 10 m/s. When the air blasting speed of the dry air 37 is slower than 0.05 m/s, vaporization of the moisture from the droplets 44 may not sufficiently make progress, and the productivity may be degraded. When the air blasting speed is faster than 20 m/s, moisture from the droplets 44 rapidly vaporize, which may cause distortion of the holes 37 to be formed.

When the dew point of the dry air 37 is represented as TD2 (° C.), it is preferable that the relation between the dew point and the film surface temperature TL (° C.) be represented as (TL−TD2)° C.≧1° C. With this configuration, it is possible to stop the growth of the droplets 44 of the high-polymer film 40 at the dry zone 33 to volatilize moisture constituting the droplets 44 as water vapor 48.

For air blasting of wind from the air blower 34 to dry the high-polymer film 40, besides a method of sending wind by use of 2D nozzle, drying the high-polymer film 40 is enabled by a method of drying under reduced pressure. By drying the high-polymer film 40 under reduced pressure, each of the vaporization rates of the organic solvent 42 and the moisture 43 from the droplets 44 can be controlled. By controlling these vaporization rates, it is possible to form the droplets 44 in the high-polymer film 40 and vaporize the droplets 44 while vaporizing the organic solvent 42 to thereby change the size and the shape of holes 47 at the positions where the droplets reside on the high-polymer film 40.

It is also possible to dry the high-polymer film 40 by a method of drying under reduced pressure, and a method of which a condenser having grooves on the surface thereof which is more cooled than the film surface is provided at the position around 3 mm to 20 mm away from the film surface, and water vapor (including vaporized organic solvent) is condensed on the surface of the condenser to thereby dry the high-polymer film 40. Since the high-polymer film 40 can be dried with reducing dynamic influence upon the film surface of the high-polymer film 40 by using any one of the drying methods, it is possible to obtain a smoother film surface.

In addition, by utilizing a plurality of air blasting units of the air blower 34, and the dryer 36, and by partitioning the dry zone into plural zones, it is possible to set different conditions of dew point and to set different conditions of drying temperature. By selecting these conditions, the dimension controllability and the uniformity of holes 47 can be improved. It should be noted that the number of air blasting units and zones are not particularly limited, however, it is preferable to determine the optimum combination in view of quality of film and cost performance of units.

It is preferred that the relation between the film surface temperature TL (° C.) and the dew point temperature TDn (° C.) (“n” represents a zone number) of the dropwise condensation zone or the drying zone be represented as 0° C.<TDn−TL° C.≦80° C. By setting the difference between the film surface temperature TL (° C.) and the dew point temperature TDn (° C.) to 80° C. or less, rapid vaporization of at least any one of the organic solvent and the moisture can be prevented to thereby obtain a film having a honeycomb structure 12 in a desired form. When impurities are mixed in the high-polymer film 40, the contamination causes an impediment in forming a honeycomb structure. To prevent the contamination, it is preferable that the dust level of the blast vents 34a, 34c, 34e, 36a, 36c, 36e, and 36g be class 1000 or less. To achieve the purpose, it is preferable that an air-conditioning unit 39 be mounted on a housing 38 in which the air blower 34 and the dryer 36 are equipped to perform air-conditioning inside the housing 38. With this configuration, the possibility that impurities are mixed in the high-polymer film 40 is reduced, and an excellent film having a honeycomb structure 12 can be obtained.

The film having a honeycomb structure 12 that the drying makes progress on the surface thereof is stripped from the flow casting belt 26 while being supported by the film-exfoliation roller 30 and then rewound to the rewinder 31. The transportation speed of the film having a honeycomb structure 12 is not particularly limited, however, it is preferably 0.1 m/min to 60 m/min. When the transportation speed is slower than 0.1 m/min, the productivity may degrade, and it is unfavorable in terms of cost performance. In contrast, when the transportation speed is faster than 60 m/min, the film having a honeycomb structure 12 tears, because an excessive surface tension is given to the film having a honeycomb structure 12 during the time when the film having a honeycomb structure is transported, and it may be a cause of failures such as distortion of the film having a honeycomb structure. Through the above-noted methods, the film having a honeycomb structure 12 can be consecutively produced.

The obtained film having a honeycomb structure is subjected to a stretching treatment by the stretching step to thereby form ellipsoidal or slit-like holes on the film.

Further, in the case of an optical functional film, a metal layer can also be formed on the film surface in accordance with the necessity.

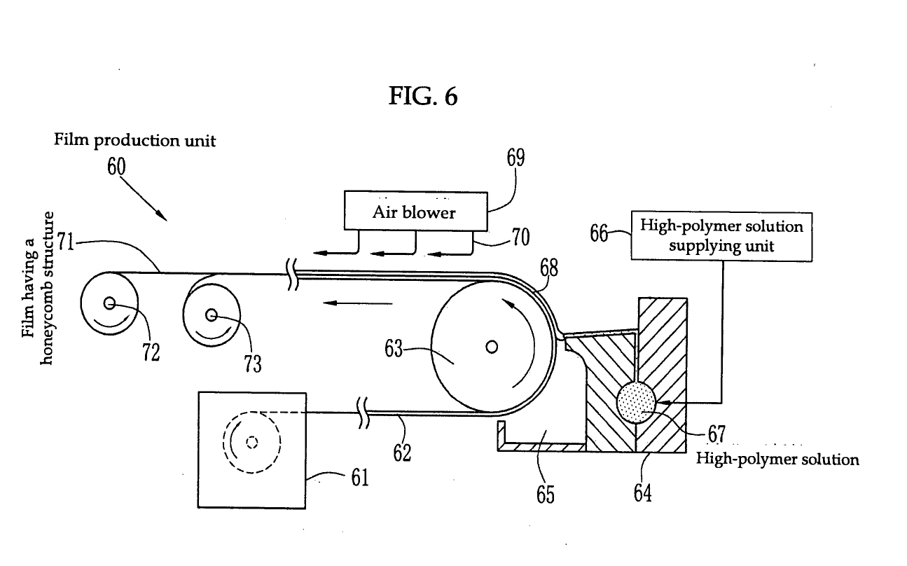

FIG. 6 shows another example of a film production unit 60 relating to the present invention. A film 62 which is to be a substrate is transported from a film sender 61. The film 62 is transported with being wound on a backup roller 63. A slide coater 64 is arranged so as to face the backup roller 63. A depressurized chamber 65 is equipped with the slide coater 64. A high-polymer solution 67 sent from a high-polymer solution supplying unit 66 by a solution sending pump is pushed out from the slide coater 64 and is applied over the surface of the film 62 which is a substrate, thereby forming a high-polymer film 68.

The slide coater 64 excels in the uniform coating property in the transportation direction of the film 62 and enables forming the high-polymer film 68 at high speed, and thus it can be said as a coater which also excels in high-productivity. Even when the concave and convex portions are formed on the surface of the film 62 which is to be a substrate, the film 62 is smoothly formed when the film 62 is wound on the backup roller 63, and thus, the slide coater 64 also excels in the uniform coating property. Further, the slide coater 64 enables uniform coating, because the high-polymer solution 67 can be applied to the surface of the film 62 in non-contact with the film 62 by the slide coater 64, without hurting the surface of the film 62.

The high-polymer film 68 formed on the film 62 is subjected to a dropwise condensation and drying step 11 by use of wind 70 sent from an air blower 69. For the explanations of the dropwise condensation and drying step 11, the portions of the same conditions as the aforesaid explained portions will be omitted. After the high-polymer film 68 is subjected to the dropwise condensation and drying step 11, a film having a honeycomb structure 71 is rewound to a wind roll 72. The film 62 is also rewound to the wind roll 73. The transportation direction of the film 62 on which the high-polymer film 68 is to be formed is preferably set at an angle of within ±10° C. to the horizontal direction. It is more preferable that a material that easily absorbs the organic solvent of the high-polymer solution 66 be used for the film 62. The material is not particularly limited and may be suitably selected in accordance with the intended use, provided that the material absorbs the organic solvent. For example, when methyl acetate is used for the main solvent of the high-polymer solution 67, it is preferable to use cellulose acetate as the material of the film 62.

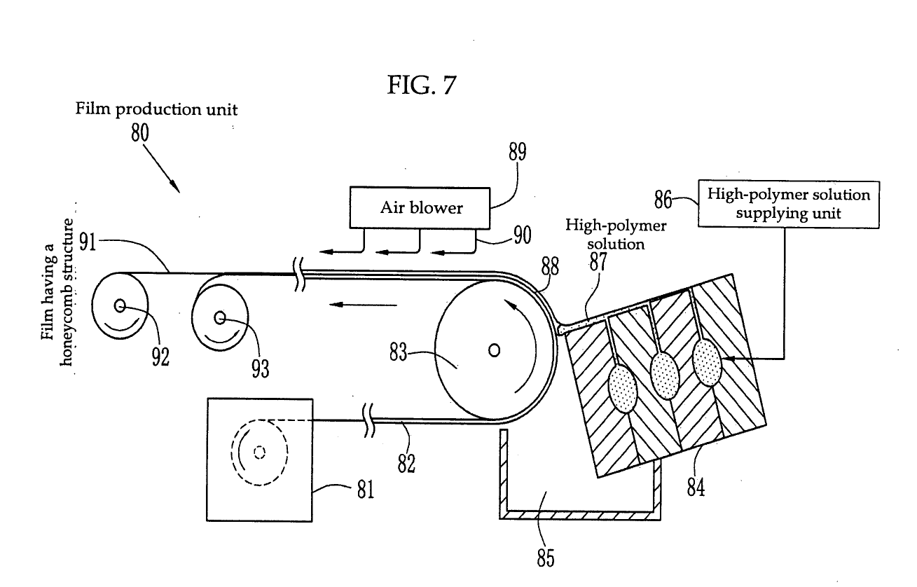

FIG. 7 shows yet another example of a film production unit 80 used for the method for producing a film of the present invention. It should be noted that the explanations on the same portions as those of the film production unit 60 will be omitted. A film 82 which is to be a substrate is transported from a film sender 81 while being wound on a backup roller 83. A multilayer-type slide coater 84 is arranged so as to face the backup roller 83. A depressurized chamber 85 is equipped with the multilayer-type slide coater 84. A high-polymer solution 87 sent from a high-polymer solution supplying unit 86 by a solution sending pump is pushed out from the multilayer-type slide coater 84 and is applied over the surface of the film 82 which is a substrate to thereby form a high-polymer film 88. The high-polymer film 88 formed on the film 82 is subjected to a dropwise condensation and drying step 11 by use of wind 90 from an air blower 89. After the high-polymer film 88 is subjected to the dropwise condensation and drying step, a film having a honeycomb structure 91 is rewound to a wind roll 92. The film 82 is also rewound to the wind roll 93.

The form of the film having a honeycomb structure 91 in the thickness direction, and the physical properties thereof can be changed by casting or applying a multilayered high-polymer solution 87 over the surface of the film 82.

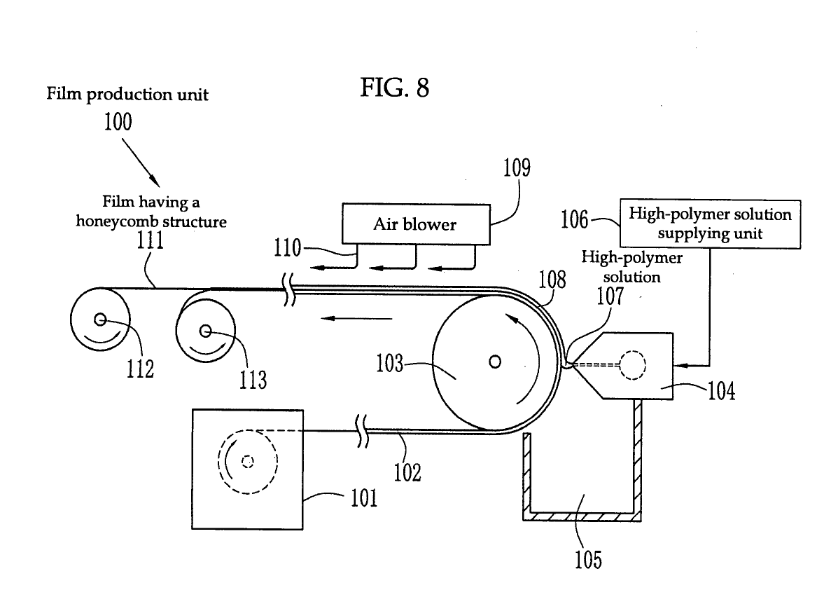

FIG. 8 shows still yet another example of a film production unit 100 used for the method for producing a film of the present invention. It should be noted that the explanations of the same portions as those of the film production unit 60 will be omitted. A film 102 which is to be a substrate is transported from a film sender 101 while being wound on a backup roller 103. An extrusion coater 104 is arranged so as to face a backup roller 103. The extrusion coater 104 is equipped with a depressurized chamber 105. A high-polymer solution 107 sent from a high-polymer solution supplying unit 106 by a solution sending pump is pushed out from the extrusion coater 104 and is applied over the surface of the film 102 which is a substrate to thereby form a high-polymer film 108. The high-polymer film 108 formed on the film 102 is subjected to a dropwise condensation and drying step 11 by use of wind 110 from an air blower 109. After the high-polymer film 108 is subjected to the dropwise condensation and drying 11, a film having a honeycomb structure 111 is rewound to a wind roll 112. The film 102 is also rewound to the wind roll 113.

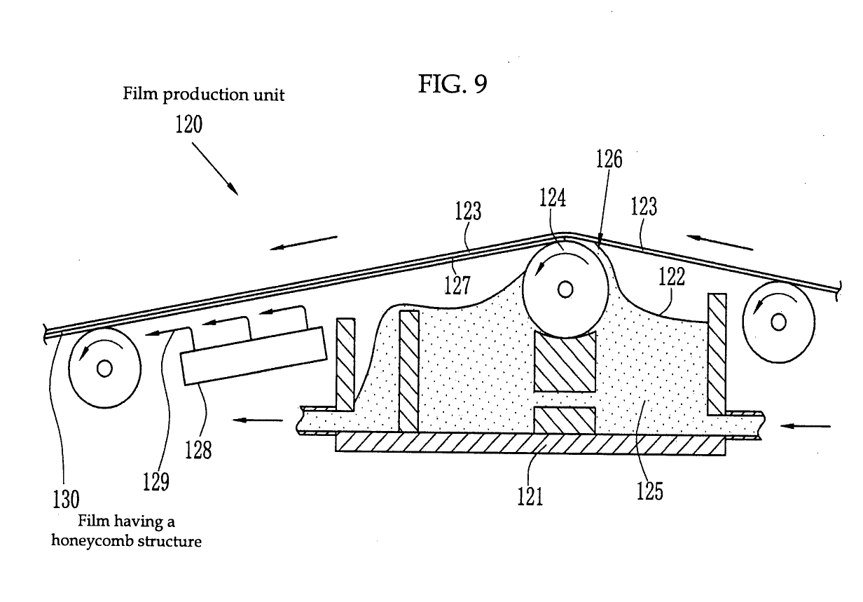

With reference to FIG. 9 showing a film production unit 120 which produces a film of the present invention, the method for producing a film of the present invention will be explained. A high-polymer solution 122 is applied over the surface of a film 123 using a wire-bar coater 121. A wire bar which rotates in the moving direction of the film 123 moving at a constant speed pulls the high-polymer solution 122 out of a primary side of a high-polymer solution tank 125 up to a solution retaining portion 126. By making the high-polymer solution 122 in the solution retaining portion contact with the film 123 through the wire bar 124, a high-polymer film having a uniform thickness 127 can be formed. By subjecting the high-polymer film 127 to a dropwise condensation and drying step 11 by use of wind 129 from an air blower 128, a film having a honeycomb structure 130 can be obtained. According to the method for forming a film having a honeycomb structure 130 using the wire bar 124, the solution retaining portion 126 prevents air from getting mixed in the contact portion between the high-polymer solution 122 and the film 123, and thus the method is advantageous in that air bubbles are rarely mixed in the high-polymer film 127.

When the films 62, 82, 102, and 123 are used as a substrate, each of the films 62, 82, 102, and 123 and each of the film having a honeycomb structures 71, 91, 111, and 130 can be rewound as an integrally formed film to use the film as a base film of the optical functional film 14.

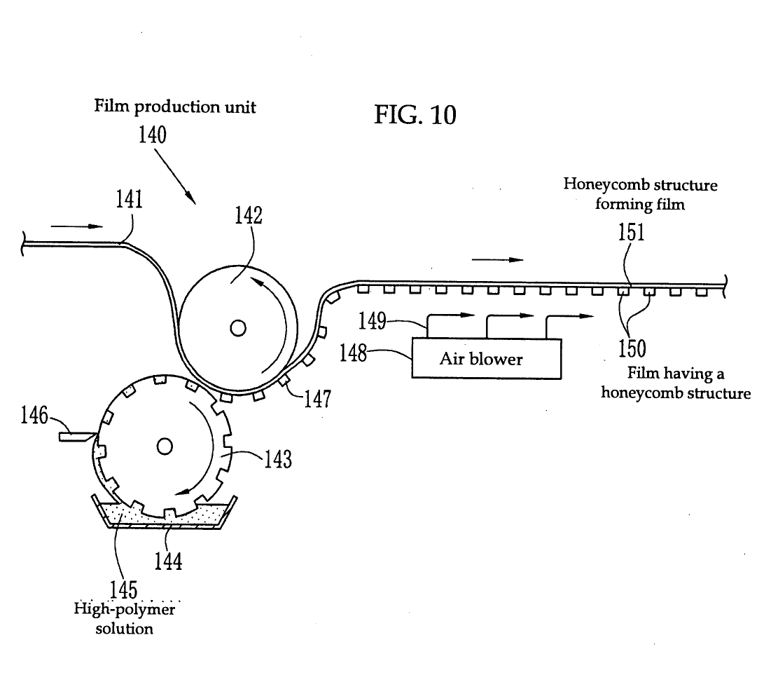

FIG. 10 shows a film production unit 140 used for producing a film of the present invention. In the film production unit 140, a film 141 is transported while being wound on an impression cylinder 142. A printing cylinder 143 is arranged so as to face the impression cylinder 142. A desired pattern is formed on the surface of the printing cylinder 143. A high-polymer solution 145 poured in a high-polymer solution tank 144 accumulates in the convex portions of the printing cylinder 143 by rotation of the printing cylinder 143. An excessive amount of the high-polymer solution 145 is scooped out by a doctor blade 146. Thereafter, the high-polymer solution 145 is applied on the surface of the film 141 which is traveling in a state of being wound on the impression cylinder 142 to thereby form a high-polymer film 147.

The high-polymer film 147 is subjected to a dropwise condensation and drying step 11 by use of an air blower 148. The direction to which the wind 149 sent from the air blower 148 is sent is the parallel current flow, which is the same direction as the transportation direction of the film 141. The high-polymer film 147 is subjected to a dropwise condensation and drying step 11 to thereby form a film having a honeycomb structure 150. The film 141 becomes a honeycomb structure forming film 151 on which a film having a honeycomb structure 150 is formed with a desired pattern.

An optical functional film or a composite film of the present invention obtained in accordance with the method for producing an optical functional film or a composite film of the present invention may be used directly after the film is produced on an intended substrate from the beginning, or may be used after the film is soaked in an appropriate solvent such as ethanol, and then the film is exfoliated from a substrate used in the production to be set on an intended base. When the optical functional film or the composite film is used after exfoliating it from a substrate, for the purpose of increasing adhesiveness with a new base material, an adhesive such as epoxy resin, and silane coupling agent, which fits the material and is suited to the quality of a desired base material may be used.

### EXAMPLES

Hereinafter, the present invention will be described in detail referring to specific examples, however, the present invention is not limited to the disclosed examples.

### Example 1

Polystyrene having a weight average molecular mass of 45,000 was mixed with an amphipathic polymer represented by the following structural formula having a weight average molecular mass of 50,000 at a mass ratio of 10:1, and the mixture was dissolved in a methylene chloride solution to thereby prepare a methylene chloride solution in an amount of 0.5 mL (0.1% by mass as the polymer concentration).

Next, the total amount of the methylene chloride solution was applied over a surface of a glass substrate for HDD which was kept warm at 2° C. in a confined space that was free from outside influence, and air of constant humidity having a relative humidity of 70% was sprayed from the direction of an angle of 45° relative to the substrate surface at a constant flow rate of 2 L/m to vaporize methylene chloride and to thereby obtain a film having a honeycomb structure having a uniform thickness. The air of constant humidity was supplied after connecting a humidity generator manufactured by Yamato Scientific Co., Ltd. to a compressor SC-820 manufactured by Hitachi Koki Co., Ltd., equipped with a commercially available dust removing air filter (rated filtration: 0.3 μm). The measured flow rate of the air at the spraying part was 0.3 m/s.

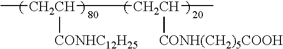

The structure of the obtained film was observed using a field emission scanning electron microscope (S4300, manufactured by Hitachi High-Technologies Corporation), and it was confirmed that a film having a honeycomb structure in which holes having a pore diameter of 510 nm were arranged in a hexagonal form with regularity. The interval of center-to-center spacing between two adjacent holes was 620 nm. The holes were formed in a single layer so as to completely pass through from the top surface of the film to the back side surface. The holes ranged over the film almost entirely, and each of the holes was spherically shaped.

Next, the obtained film having a honeycomb structure were held at the both ends thereof with clips and then stretched in the width direction while being transported. The film was stretched at a stretching degree of 200% to thereby prepare a honeycomb film in which ellipsoidal holes each surrounded by a wall surface were arrayed linearly, as shown in FIG. 1. A metal layer (Ni) was formed selectively on polymer matrix areas of a surface of the obtained honeycomb-like porous film except for the hole portions by subjecting the honeycomb-like porous film to a nonelectrolytic plating treatment to thereby produce a polarizing film as an optical functional film having a structured pattern of a pitch width of 250 nm and a thickness of 500 nm.

The obtained polarizing film had excellent polarization properties.

### Example 2

A polarizing film as an optical functional film was produced in the same manner as in Example 1 except that a honeycomb-like porous film in which slit-like holes were arrayed linearly by increasing the stretching degree to 400%.

### Example 3

A polarizing film as an optical functional film was produced in the same manner as in Example 1 except that polystyrene having a weight average molecular mass of 45,000 was mixed with an amphipathic polymer represented by the following structural formula having a weight average molecular mass of 50,000 at a mass ratio of 70:30 to prepare 0.5 mL of a methylene chloride solution (0.1% by mass as the polymer concentration).

### Example 4

A polarizing film as an optical functional film was produced in the same manner as in Example 1 except that only polystyrene having a weight average molecular mass of 45,000 was dissolved in a methylene chloride solution to prepare 0.5 mL of a methylene chloride solution (0.1% by mass as the polymer concentration).

### Example 5

A polarizing film as an optical functional film was produced in the same manner as in Example 1 except that only amphipathic polymer represented by the following structural formula was dissolved in a methylene chloride solution to prepare 0.5 mL of a methylene chloride solution (0.1% by mass as the polymer concentration).

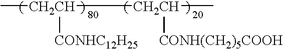

### Example 6

A polarizing film as a composite film was produced in the same manner as in Example 1 except that a metal layer (Ni) was formed on a honeycomb-like porous film including inside portions of the holes by subjecting the honeycomb-like porous film to a nonelectrolytic plating treatment.

### Example 7

A polarizing film as a composite film was produced in the same manner as in Example 6 except that a honeycomb-like porous film of which slit-like holes same as those of Example 2 were arrayed linearly.

### Example 8

A polarizing film as a composite film was produced in the same manner as in Example 6 except that polystyrene having a weight average molecular mass of 45,000 was mixed with an amphipathic polymer represented by the following structural formula having a weight average molecular mass of 50,000 at a mass ratio of 70:30 to prepare 0.5 mL of a methylene chloride solution (0.1% by mass as the polymer concentration).

### Example 9

A polarizing film as a composite film was produced in the same manner as in Example 6 except that only polystyrene having a weight average molecular mass of 45,000 was dissolved in a methylene chloride solution to prepare 0.5 mL of a methylene chloride solution (0.1% by mass as the polymer concentration).

### Example 10

A polarizing film as a composite film was produced in the same manner as in Example 6 except that only amphipathic polymer represented by the following structural formula was dissolved in a methylene chloride solution to prepare 0.5 mL of a methylene chloride solution (0.1% by mass as the polymer concentration).

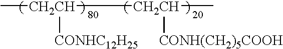

### Comparative Example 1

PVA 205 (manufactured by KURARAY Co., Ltd.) was used as a 10% aqueous solution and cast on a surface of a glass plate to prepare a film having a thickness of 300 μm. The film was heated to approx. 120° C. using an electric heater and stretched to 200% at the same time. Then, the film was soaked in a potassium iodine iodide solution (3 g of potassium iodide and 0.5 g of iodine were dissolved in 100 mL of water to prepare the solution) at room temperature (25° C.) for 5 seconds, and the solution on the film surface was completely wiped away with paper towel and dried to thereby prepare a polarizing film.

### Comparative Example 2

A polarizing film was produced in the same manner as in Example 1 except that a honeycomb-like porous film of which holes each formed in a substantially perfect circle shape were arrayed was produced without subjecting the honeycomb-like porous film to a stretching treatment.

### Comparative Example 3

A polarizing film was produced in the same manner as in Comparative Example 1 except that the stretching degree of the film was increased to 400%.

### Comparative Example 4

A composite film was produced in the same manner as in Example 6 except that a honeycomb-like porous film of which holes each formed in a substantially perfect circle shape were arrayed was produced in Example 6.

<Evaluation on Polarization Properties>

Each of the films obtained in Examples 1 to 10 and Comparative Examples 1 to 4 was used as a polarizing plate, and the polarizing plate was mounted on a liquid crystal cell. Then, a rectangular-wave voltage of 55 Hz was applied to each of the liquid crystal cells. In the normally white mode, the each of the liquid crystal cells was applied with the voltage in white display at 2V and in black display at 5V, the ratio of transmittance as contrast ratio (white display/black display) of the each of the liquid crystal cells was measured using a measuring instrument (EZ-Contrast 160D, manufactured by ELDIM) to thereby evaluate the films. Table 1 shows the results of the evaluation.

<Evaluation of Durability>

From each of the films obtained in Examples 1 to 10 and Comparative Examples 1 to 4, two sheets of sample film of 10 cm×10 cm in size were prepared, respectively. The each of the sample films was subjected to a treatment of high-temperature and humidity, at a temperature of 40° C. and a relative humidity of 90%, for 500 hours. Then, the polarization degree of each of the sample film was calculated based on the following Equation 1, and from the calculated results, the each of the obtained films was evaluated in terms of durability based on the following evaluation criteria. Table 1 shows the results of the evaluation.
Polarization degree P=((Tp−Tc)/(Tp+Tc))ˆ0.5 Equation 1

In Equation 1, Tp represents a transmittance (%) determined when the absorption axes of the two sheets of sample films are overlaid each other in parallel, and Tc represents a transmittance (%) determined when the absorption axes of the two sheets of the sample films are overlaid perpendicular to each other.

The transmittance (%) was measured by use of a spectrophotometer (UV-3100PC, manufactured by Shimadzu Corporation) and calculated from a spectral transmittance τ(λ) which had been determined at intervals of 10 nm of the overlaid two sheets of sample films based on the following Equation 2:

$$Transmittance T = \frac{{\int }_{}^{} ( 780 - 380 ) P ( λ ) y ( λ ) τ ( λ ) ⅆ λ}{{\int }_{}^{} ( 780 - 380 ) P ( λ ) \cdot y ( λ ) ⅆ λ} \qquad Equation 2$$

In Equation 2, P(λ) represents a spectral distribution of the light source of standard light C; and y(λ) represents a color matching-function based on X, Y, and Z of the CIE 1931 standard calorimetric system.

[Evaluation Criteria]

A: The valuation of polarization degree before and after the treatment was 0.2% or less, and there was no problem.

B: The valuation of polarization degree before and after the treatment was 0.2% to less than 2.0% and was in the allowable range.

C: The valuation of polarization degree before and after the treatment was 2.0% or more.

TABLE 1

| | Polarization Properties | |
|---|---|---|
| | (Contrast) | Durability |
| Ex. 1 | 800:1 | B |
| Ex. 2 | 2,000:1 | B |
| Ex. 3 | 500:1 | B |
| Ex. 4 | 500:1 | B |
| Ex. 5 | 500:1 | B |
| Ex. 6 | 5,000:1 | A |
| Ex. 7 | 8,000:1 | A |
| Ex. 8 | 3,000:1 | A |
| Ex. 9 | 3,000:1 | A |
| Ex. 10 | 3,000:1 | A |
| Compara. | 1,000:1 | C |
| Ex. 1 | | |
| Compara. | (no polarization) | C |
| Ex. 2 | | |
| Compara. | 2,000:1 | C |
| Ex. 3 | | |
| Compara. | (no polarization) | C |
| Ex. 4 | | |

The results shown in Table 1 demonstrated that the optical functional film and the composite film of the present invention respectively have higher durability than that of conventional absorption type of polarizing films as shown in Comparative Examples and make it possible to obtain polarization properties with ease. However, polarizing films produced in Examples 9 and 10 respectively caused a defect of nonuniformity of shape of holes, and caused polarization leakage.

What is claimed is:

1. An optical functional film comprising:
a film having a structure of fine holes which comprise ellipsoidal or slit-like holes.

2. The optical functional film according to claim 1, wherein the film having the structure of fine holes is a honeycomb-like porous film produced by self-organization.

3. The optical functional film according to claim 1, wherein the holes respectively open in an ellipsoid or a slit shape on a surface of the film and are arrayed linearly.

4. The optical functional film according to claim 1, wherein the film is subjected to a stretching treatment, and the stretching is any one selected from uniaxial stretching, sequential biaxial stretching, simultaneous biaxial stretching, and triaxial stretching.

5. The optical functional film according to claim 1, wherein the film has a metal layer on a surface thereof except for the hole portions.

6. The optical functional film according to claim 1, wherein the material of the film is at least one selected from the group consisting of hydrophobic polymers, and amphipathic compounds.

7. The optical functional film according to claim 6, wherein the amphipathic compounds are amphipathic polymers.

8. The optical functional film according to claim 1, wherein the optical functional film is used as a polarizing film.

9. A composite film comprising:
a film having a structure of fine holes which comprise ellipsoidal or slit-like holes, and
a metal layer,
wherein the meal layer is formed on a surface of the film including inside portions of the holes.

10. The composite film according to claim 9, wherein the film having the structure of fine holes is a honeycomb-like porous film produced by self-organization.

11. The composite film according to claim 9, wherein the film is subjected to a stretching treatment, and the stretching is any one selected from uniaxial stretching, sequential biaxial stretching, simultaneous biaxial stretching, and triaxial stretching.

12. The composite film according to claim 9, wherein the film has a metal layer inside the holes and has a wire grid function.

13. The composite film according to claim 9, wherein the material of the film is at least one selected from the group consisting of hydrophobic polymers, and amphipathic compounds.

14. The composite film according to claim 13, wherein the amphipathic compounds are amphipathic polymers.

15. A method for producing an optical functional film comprising:
forming a film, and
stretching the obtained film to form ellipsoidal or slit-like holes in the film,
the forming the film comprises
applying a coating solution containing an organic solvent and a high-polymer compound over a surface of a substrate,
forming droplets in the obtained film, and
vaporizing the organic solvent and the droplets to thereby produce a film having holes in the film.

16. The method for producing an optical functional film according to claim 15, wherein the stretching is any one selected from uniaxial stretching, sequential biaxial stretching, simultaneous biaxial stretching, and triaxial stretching.

17. The method for producing an optical functional film according to claim 15, further comprising forming a metal layer on a surface of the film except for the hole portions.

18. A method for producing a composite film comprising:
forming a film,
stretching the obtained film to form ellipsoidal or slit-like holes in the film, and
forming a metal layer on a surface of the film including inside portions of the holes,
the forming the film comprises
applying a coating solution containing an organic solvent and a high-polymer compound over a surface of a substrate,
forming droplets in the obtained film, and
vaporizing the organic solvent and the droplets to thereby produce a film having holes in the film.

19. The method for producing a composite film according to claim 18, wherein the stretching is any one selected from uniaxial stretching, sequential biaxial stretching, simultaneous biaxial stretching, and triaxial stretching.
